(19) United States
(12) Patent Application Publication
(10) Pub. No.: US 2026/0278917 A1
(43) Pub. Date: Sep. 17, 2026

(54) REGION-WISE PROPAGATION OF DISPLAY PARAMETER ADJUSTMENTS

(71) Applicant: GE Precision Healthcare LLC, Waukesha, WI (US)

(72) Inventors: Charly Girot, Paris (FR); Jorge Eduardo HERNANDEZ LONDONO, Versailles (FR); Pierrick CHEVAILLIER, Antony (FR); Walter Yvart, Fleurance (FR); Michail Fanariotis, Skien (NO)

(21) Appl. No.: 19/081,433

(22) Filed: Mar. 17, 2025

(51) Int. Cl. G06T 15/08; G06T 5/60; G06T 7/00; G06T 7/11

(52) U.S. Cl. CPC G06T 15/08; G06T 5/60; G06T 7/0012; G06T 7/11; G06T 2207/20076; G06T 2207/20081; G06T 2207/20104; G06T 2207/30061; G06T 2210/41

(57) ABSTRACT

Systems/techniques that facilitate region-wise propagation of display parameter adjustments are provided. In various embodiments, a system can display on an electronic screen a medical image depicting a plurality of anatomical regions of a medical patient. In various aspects, the system can, in response to an instruction requesting an adjustment to a display parameter of a first one of the plurality of anatomical regions, perform the adjustment on the display parameter of the first one of the plurality of anatomical regions and perform propagated versions of the adjustment on the display parameter of remaining ones of the plurality of anatomical regions.

### TECHNICAL FIELD

The subject disclosure relates generally to medical imaging, and more specifically to region-wise propagation of display parameter adjustments.

### BACKGROUND

A medical image can be electronically displayed or rendered according to a display parameter. Different anatomical regions within the medical image can be more visible or less visible when the display parameter is set to different specific values. Adjusting the display parameter so as to better view different anatomical regions can be laborious or time-consuming.

Accordingly, systems or techniques that can address one or more of these technical problems can be desirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate region-wise propagation of display parameter adjustments are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise a display component that can display on an electronic screen a medical image depicting a plurality of anatomical regions of a medical patient. In various aspects, the computer-executable components can comprise an adjustment component that can, in response to an instruction requesting an adjustment to a display parameter of a first one of the plurality of anatomical regions, perform the adjustment on the display parameter of the first one of the plurality of anatomical regions and perform propagated versions of the adjustment on the display parameter of remaining ones of the plurality of anatomical regions.

According to one or more embodiments, a computer-implemented method is provided. In various embodiments, the computer-implemented method can comprise displaying, by a device operatively coupled to a processor, on an electronic screen a medical image depicting a plurality of anatomical regions of a medical patient. In various aspects, the computer-implemented method can comprise performing, by the device and in response to an instruction requesting an adjustment to a display parameter of a first one of the plurality of anatomical regions, the adjustment on the display parameter of the first one of the plurality of anatomical regions and propagated versions of the adjustment on the display parameter of remaining ones of the plurality of anatomical regions.

According to one or more embodiments, a computer program product for facilitating region-wise propagation of display parameter adjustments is provided. In various embodiments, the computer program product can comprise a non-transitory computer-readable memory having program instructions embodied therewith. In various aspects, the program instructions can be executable by a processor to cause the processor to render a scanned medical image. In various instances, the program instructions can be executable to cause the processor to propagate, in response to an input specifying an adjustment to be made to a rendition parameter of a first anatomical structure depicted in the scanned medical image, a version of the adjustment to the rendition parameter of a second anatomical structure depicted in the scanned medical image.

### DESCRIPTION OF THE DRAWINGS

FIG. 1 illustrates a block diagram of an example, non-limiting system that facilitates region-wise propagation of display parameter adjustments in accordance with one or more embodiments described herein.

FIG. 2 illustrates a block diagram of an example, non-limiting system including a plurality of original display parameter values that facilitates region-wise propagation of display parameter adjustments in accordance with one or more embodiments described herein.

FIG. 3 illustrates a block diagram of an example, non-limiting system including a requested display adjustment and a set of propagated display adjustments that facilitates region-wise propagation of display parameter adjustments in accordance with one or more embodiments described herein.

FIGS. 4-8 illustrate example, non-limiting block diagrams showing how a set of propagated display adjustments can be created based on a requested display adjustment in accordance with one or more embodiments described herein.

FIGS. 9-16 illustrate example, non-limiting experimental results in accordance with one or more embodiments described herein.

FIG. 17 illustrates a flow diagram of an example, non-limiting computer-implemented method that facilitates region-wise propagation of display parameter adjustments in accordance with one or more embodiments described herein.

FIG. 18 illustrates a block diagram of an example, non-limiting operating environment in which one or more embodiments described herein can be facilitated.

FIG. 19 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A medical image can be a pixel array or a voxel array that visually depicts anatomical regions (e.g., organs, tissues, bodily fluids, bodily cavities, other anatomical structures) of a medical patient (e.g., human, animal, or otherwise). Medical images can be electronically captured or generated by any suitable medical imaging equipment (e.g., by computed tomography (CT) scanners, by magnetic resonance imaging (MRI) scanners, by X-ray scanners, by ultrasound scanners, by positron emission tomography (PET) scanners, by nuclear medicine (NM) scanners). After being captured or generated, medical images can undergo any suitable types of image processing techniques (e.g., image reconstruction, multiplanar reconstruction, image classification, image segmentation, image denoising, image regression). For example, anatomical region segmentation or localization can be performed on a medical image, so as to determine which specific pixels or voxels make up or belong to each respective anatomical region that is depicted in the medical image.

In any case, a medical image can be electronically displayed or rendered on a computer screen, such that a medical professional (e.g., physician, nurse, technologist) can visually inspect the medical image for diagnostic or prognostic purposes. The computer screen can facilitate such display or rendition by utilizing a display parameter (e.g., window width, window level) which can govern or otherwise control how (e.g., with what colors or shades) individual pixels or voxels within the medical image are visualized or otherwise visually represented. A given anatomical region within the medical image can be more visible when the display parameter is set to certain specific values and can instead be less visible when the display parameter is instead set to other specific values. Equivalently, at a given value of the display parameter, some anatomical regions (e.g., bones) can have better visibility while other anatomical regions (e.g., lungs) can have worse visibility. Because bad visibility of an anatomical region can negatively or adversely affect diagnosis or prognosis quality, implementation of a single or global value of the display parameter for the entire medical image can be considered as disadvantageous or suboptimal.

Existing techniques attempt to address this visibility problem by implementing region-wise values for the display parameter. Indeed, as mentioned above, anatomical regions can be segmented or otherwise localized within a medical image. Thus, it can be known which individual pixels or voxels of the medical image belong to or make up which anatomical regions of the medical image. Rather than applying a single, global, or universal value of the display parameter to each pixel or voxel of the medical image, existing techniques apply respective or different values of the display parameter to the pixels or voxels of different anatomical regions. For instance, existing techniques can cause the display parameter to take on a first value for whichever pixels or voxels belong to a first anatomical region (e.g., bones) and can cause the display parameter to instead take on a second value for whichever pixels or voxels belong to a second anatomical region (e.g., lungs). By visualizing different anatomical regions using different or respective values of the display parameter, it can be possible for all the anatomical regions in the medical image to be simultaneously displayed or rendered with good or sufficient visibility.

Unfortunately, as the inventors of various embodiments described herein recognized, such existing techniques nevertheless suffer from a technical problem. Specifically, when such existing techniques are implemented, adjustment of the display parameter by a user can become excessively laborious or time-consuming. Indeed, the present inventors recognized that existing techniques treat the display parameter values of whatever anatomical regions are depicted in a medical image as being wholly or completely isolated from, separate from, or independent of each other. For instance, suppose that the pixels or voxels belonging to a first anatomical region in the medical image are visualized using a first value of the display parameter. Furthermore, suppose that a medical professional who is visually inspecting the medical image determines or judges that the visual inspection would be better if the pixels or voxels belonging to the first anatomical region were instead visualized using a second value of the display parameter. In such case, the medical professional can manually adjust or change (e.g., via a human-computer interface device, such as a keyboard or computer mouse) the first value to the second value, thereby changing or modifying how the pixels or voxels that make up the first anatomical region are visualized. When existing techniques are implemented, such manual adjustment leaves totally untouched the values of the display parameter that are implemented for all the remaining anatomical regions in the medical image. It is often the case that the medical professional will want or desire to respectively adjust the display parameter for multiple other anatomical regions in conjunction with the above adjustment for the first anatomical region. Because the medical image can depict tens or dozens of distinct anatomical regions, such existing techniques can require the medical professional to spend up to several minutes manually performing such adjustments one by one (e.g., first manually adjusting the display parameter for depicted bone tissue, then manually adjusting the display parameter for depicted lung tissue, followed by manually adjusting the display parameter for depicted liver tissue). Additionally, such time-consumption can be significantly exacerbated by the fact that the medical professional will often not know a priori what specific value to which to set the display parameter of any individual anatomical region. Instead, for each given anatomical region, the medical professional will often settle upon a new display parameter value only after tinkering or toying with the display parameter of that given anatomical region in trial-and-error fashion (e.g., to see which new value of the display parameter of the given anatomical region yields a best or most desirable visualization of the given anatomical region). Thus, existing techniques can be considered as effort-intensive and disruptive to the visual inspection being performed by the medical professional. In other words, such existing techniques can force the medical professional to spend excessive amounts of time or effort on diagnosing or prognosing whatever medical patient whose anatomical regions are depicted in the medical image. This can be considered as undesirable or disadvantageous.

So, systems or techniques that can address one or more of these technical problems can be desirable.

Various embodiments described herein can address one or more of these technical problems. One or more embodiments described herein can include systems, computer-implemented methods, apparatus, or computer program products that can facilitate region-wise propagation of display parameter adjustments. In particular, a medical image depicting a plurality of anatomical regions can be rendered on a computer screen, and the computer screen can accomplish such rendition via a display parameter that has different values respectively corresponding to the plurality of anatomical regions. A medical professional can provide an electronic instruction to adjust the display parameter for any given anatomical region depicted in the medical image. In response to such electronic instruction, various embodiments described herein can implement the instructed adjustment with respect to the display parameter of the given anatomical region and can also propagate respective versions of the instructed adjustment to the display parameter of the remaining anatomical regions in the medical image. In some cases, such propagation can be facilitated by an adjustment coefficient, which various embodiments described herein can explicitly compute or derive from the electronic instruction. In other cases, such propagation can instead be facilitated via execution of a machine learning model (e.g., a deep learning neural network) that is trained as described later herein. In any of such cases, the display parameter values of all of the anatomical regions can be respectively adjusted, notwithstanding that the medical professional specified an adjustment only form the display parameter value of the single given anatomical region. In other words, various embodiments described herein can be considered as treating the display parameter values of the plurality of anatomical regions in an interdependent or intertwined fashion, rather than in an independent, separate, or isolated fashion. Thus, when the medical professional specifies a display parameter adjustment to any one anatomical region, all the other anatomical regions can be automatically and commensurately adjusted without additional manual tinkering on the part of the medical professional. Thus, a total amount of time or effort expended by the medical professional in arriving at a diagnosis or prognosis based on the medical image can be significantly reduced, as compared to existing techniques.

Various embodiments described herein can be considered as a computerized tool (e.g., any suitable combination of computer-executable hardware or computer-executable software) that can facilitate region-wise propagation of display parameter adjustments. In various aspects, such computerized tool can comprise a display component and an adjustment component.

In various embodiments, there can be a medical image. In various aspects, the medical image can be any suitable two-dimensional pixel array or three-dimensional voxel array generated or captured by any suitable medical imaging modality (e.g., can be a CT scanned image; can be an X-ray scanned image; can be an MRI scanned image) and can depict any suitable anatomical structures or portions thereof of any suitable medical patient. In various instances, the medical image can have undergone any suitable type of anatomical segmentation or localization procedure, such that it is known which specific pixels or voxels of the medical image form or constitute each anatomical structure (e.g., each pixel or voxel can belong to a respective anatomical structure). In other words, each pixel or voxel of the medical image can be considered as having a respective label that indicates or specifies to which anatomical structure that pixel or voxel belongs.

Although it is often the case that each pixel or voxel belongs to exactly one anatomical structure (e.g., has exactly one label), this is a mere non-limiting example. Indeed, in some cases, it can be possible for a pixel or voxel to belong to multiple anatomical structures that are nested or embedded within each other (e.g., such that a pixel or voxel can have multiple labels). For example, a given pixel or voxel might belong to a liver lobe, which is necessarily nested or located inside of a liver. Thus, that given pixel or voxel can have a first label indicating membership to the liver and a second label indicating membership to a liver lobe. As another example, a certain pixel or voxel might belong to a lung artery, which is necessarily nested or located inside of a lung. So, that certain pixel or voxel can have a first label indicating membership to the lung and a second label indicating membership to a lung artery.

In various embodiments, there can be an electronic display. In various aspects, the electronic display can be any suitable type of computerized device which can display or render electronic data in a viewable or readable fashion. For instance, the electronic display can be any suitable type of computer screen, computer monitor, or electronic visual projection device. In various cases, the electronic display can utilize or otherwise be associated with a display parameter. In various aspects, the display parameter can be considered as a configurable or selectable software setting of the electronic display that controls, governs, or otherwise affects how the electronic display visually manifests electronic data. For instance, the display parameter can be window width (e.g., can control how many different Hounsfield unit values are depicted by the electronic display via shades or gradations of grey) or window level (e.g., can control which Hounsfield unit value within the window width is depicted by the electronic display via a central or midpoint shade or gradation of grey).

It can be desired for the medical image to be visually displayed or rendered on the electronic display. In various cases, the computerized tool can accomplish such visual display or rendition as described herein.

In various embodiments, the computerized tool can electronically access the medical image. For instance, the computerized tool can receive, retrieve, or otherwise obtain the medical image from any suitable centralized or decentralized data structures (e.g., graph data structures, relational data structures, hybrid data structures). Thus, any components of the computerized tool can electronically interact with (e.g., read, write, edit, copy, manipulate) the medical image. Likewise, the computerized tool can electronically access the electronic display. For instance, the computerized tool can electronically interface or communicate with (e.g., send electronic commands to, read electronic signals from) the electronic display. So, any components of the computerized tool can electronically interact with (e.g., activate, deactivate, instruct, command) the electronic display.

In various embodiments, the display component of the computerized tool can instruct, command, or otherwise cause the electronic display to visually render the medical image according to various original display parameter values. In various aspects, each of the original display parameter values can be a scalar which can be assigned to or taken on by the display parameter for whatever pixels or voxels make up or form a respective anatomical structure.

As a non-limiting example, suppose that the anatomical structures include bone tissue, lung tissue, and liver tissue, and suppose that the display parameter is window level. In such case, the original display parameter values can include three scalar values: a value A which can correspond to the bone tissue; a value B which can correspond to the lung tissue; and a value C which can correspond to the liver tissue. In such case, the display component can cause the medical image to be visually or visibly rendered on the electronic display, such that: whatever pixels or voxels of the medical image that belong to or make up the bone tissue utilize a window level having the value A; whatever pixels or voxels of the medical image that belong to or make up the lung tissue utilize a window level having the value B; and whatever pixels or voxels of the medical image that belong to or make up the liver tissue utilize a window level having the value C.

Note that the term “original” can be considered as appropriate for the original display parameter values, since the electronic display is initially or originally (e.g., before a user-instructed adjustment) using such display parameter values to visually depict or render the medical image. Furthermore, note that the original display parameter values can be identified, computed, or determined in any suitable fashion (e.g., can be whatever most recent values were used by the electronic display to respectively visualize the plurality of anatomical regions; can be averages of whatever values are empirically determined to be usually or frequently chosen by large swaths of medical professionals to respectively visualize the plurality of anatomical regions).

In various embodiments, the adjustment component of the computerized tool can electronically access (e.g., receive, retrieve, obtain) a requested adjustment to the display parameter. In various aspects, the requested adjustment can be any suitable electronic data that indicates or specifies a target display parameter value which a medical professional or other user associated with the electronic display desires to be implemented for a target anatomical structure within the medical image. For instance, the medical professional or other user can believe that setting the display parameter of the target anatomical structure to the target value will aid or ease visual inspection or interpretation of the medical image. In various cases, the medical professional or other user can supply the requested adjustment using any suitable human-computer interface device associated with the electronic display (e.g., using a computer mouse of the electronic display; using a touchscreen of the electronic display; using a keyboard of the electronic display; using a voice command system of the electronic display). In various aspects, the adjustment component can electronically cause the electronic display to visually render the medical image in accordance with the requested adjustment to the display parameter, and also in accordance with propagated versions of the requested adjustment to the display parameter.

More specifically, the adjustment component can implement the requested adjustment by changing or editing the original display parameter value associated with the target anatomical structure to the target display parameter value. In contrast, for each remaining or untargeted anatomical structure, the adjustment component can implement a respective propagated display parameter adjustment, by changing or editing the original display parameter value associated with that remaining or untargeted anatomical structure to some new display parameter value that is not specified or indicated in the requested adjustment but that is nevertheless based on the requested adjustment.

In some cases, the adjustment component can compute or calculate the new display parameter value by leveraging an adjustment coefficient that is derived from the requested adjustment. Indeed, the adjustment coefficient can be any suitable scalar value whose magnitude can be based on the original display parameter value and on the target display parameter value of the target anatomical structure. For any remaining or untargeted anatomical structure, the new display parameter value of that remaining or untargeted anatomical structure can be obtained by mathematically applying the adjustment coefficient to whatever original display parameter value corresponds to that remaining or untargeted anatomical structure. As a non-limiting example, the adjustment coefficient can be equal to a difference between the target display parameter value and the original display parameter value of the target anatomical structure. In such case, the new display parameter value of the remaining or untargeted anatomical structure can be equal to a sum between the original display parameter value of the remaining or untargeted anatomical structure and the adjustment coefficient. As another non-limiting example, the adjustment coefficient can be equal to a ratio between the target display parameter value and the original display parameter value of the target anatomical structure. In such case, the new display parameter value of the remaining or untargeted anatomical structure can be equal to a product between the original display parameter value of the remaining or untargeted anatomical structure and the adjustment coefficient. In some instances, the adjustment coefficient can be further based on statistical intensity metrics (e.g., mean intensity or percentile intensity) exhibited by whatever pixels or voxels make up the target anatomical structure. As a non-limiting example, the adjustment coefficient can be equal to a quotient achieved by dividing: a difference between the target display parameter value and the original display parameter value of the target anatomical structure; by a difference between a 90-th percentile intensity value and a 10-th percentile intensity value exhibited by the pixels or voxels that make up the target anatomical structure. In such case, the new display parameter value of the remaining anatomical region can be equal to a sum between: the original display parameter value of the remaining or untargeted anatomical structure; and a product between the adjustment coefficient and a difference between a 90-th percentile intensity value and a 10-th percentile intensity value exhibited by the pixels or voxels that make up the remaining or untargeted anatomical structure. In some aspects, the adjustment coefficient can be mathematically applied to (e.g., added to the original display value of, multiplied by the original display parameter value of) the remaining or untargeted anatomical structure in a weighted fashion (e.g., the adjustment coefficient can be multiplicatively scaled by a weight whose magnitude uniquely corresponds to the remaining or untargeted anatomical structure).

In other cases, the adjustment component can compute or calculate the new display parameter value by leveraging a deep learning neural network. Indeed, the deep learning neural network can include any suitable numbers of any suitable types of layers (e.g., input layer, one or more hidden layers, output layer, any of which can be convolutional layers, dense layers, long short-term memory (LSTM) layers, transformer layers, non-linearity layers, pooling layers, batch normalization layers, or padding layers). As another example, the deep learning neural network can include any suitable numbers of neurons in various layers (e.g., different layers can have the same or different numbers of neurons as each other). As yet another example, the deep learning neural network can include any suitable activation functions (e.g., softmax, sigmoid, hyperbolic tangent, rectified linear unit) in various neurons (e.g., different neurons can have the same or different activation functions as each other). As still another example, the deep learning neural network can include any suitable interneuron connections or interlayer connections (e.g., forward connections, skip connections, recurrent connections). Regardless of its internal architecture, the deep learning neural network can be configured to infer or predict what display parameter adjustments should be implemented for various anatomical structures (e.g., bone, lung), when given display parameter adjustments that are known or desired to be implemented for other anatomical structures (e.g., liver). So, in various aspects, the adjustment component can execute the deep learning neural network on: the original display parameter value and the target display parameter value of the target anatomical structure; and on the original display parameter value of the remaining or untargeted anatomical structure; and such execution can cause the deep learning neural network to produce as output the new display parameter value for the remaining or untargeted anatomical structure. In order for such embodiments to function reliably, the deep learning neural network can first undergo training, such as described later herein.

No matter how the adjustment component determines or identifies propagated versions of the requested adjustment, such propagated versions of the requested adjustment can be considered as being substantively commensurate with or otherwise visually harmonious with the requested adjustment. For instance, in some cases, any of the propagated versions of the requested adjustment can be in a same direction as the requested adjustment itself (e.g., if the medical professional or user requests that a window width of bone tissue be increased by a particular amount, then that request can be propagated such that the window width of lung tissue is also increased by a related amount). Indeed, same-direction propagated adjustments can be considered as helping to maintain visual consistency across the different anatomical structures in the medical image. However, in other cases, any of the propagated versions of the requested adjustment can instead be in an opposite direction as the requested adjustment itself (e.g., if the medical professional or user requests that a window width of bone tissue be increased by a particular amount, then that request can be propagated such that the window width of lung tissue is decreased by a related amount). After all, opposite-direction propagated adjustments can be considered as helping to enhance visual emphasis of one or more anatomical structures in the medical image.

In any case, the adjustment component can implement both the requested adjustment and the propagated versions of the requested adjustment. Implementation of the requested adjustment can be considered as enacting on the medical image whatever visual change is desired or wanted by the medical professional or user. In contrast, implementation of the propagated adjustments can be considered as enacting on the medical image visual changes which are not explicitly requested by the medical professional or user but which are nevertheless commensurate with or visually beneficial in view of the requested adjustment. In this way, the medical professional or user need not spend exorbitant amounts of time on sequentially adjusting the display parameter for each anatomical structure depicted in the medical image. Instead, the medical professional or user can simply adjust the display parameter for a single anatomical structure, and various embodiments described herein can automatically propagate (e.g., in same-direction or opposite-direction fashion) such adjustment to the remaining anatomical structures in the medical image. Thus, a total amount of diagnostic or prognostic effort expended by the medical professional or user can be reduced, as compared to situations in which display parameter adjustments are not propagated across anatomical structures (e.g., as compared to situations in which the display parameter values across anatomical structures are wholly or completely independent, isolated, or separate).

Various embodiments described herein can be employed to use hardware or software to solve problems that are highly technical in nature (e.g., to facilitate region-wise propagation of display parameter adjustments), that are not abstract and that cannot be performed as a set of mental acts by a human. Further, some of the processes performed can be performed by a specialized computer (e.g., medical imaging scanners, electronic computer screens, deep learning neural networks) for carrying out defined acts related to medical imaging.

For example, such defined acts can include: displaying, by a device operatively coupled to a processor, on an electronic screen a medical image depicting a plurality of anatomical regions of a medical patient; and performing, by the device and in response to an instruction requesting an adjustment to a display parameter of a first one of the plurality of anatomical regions, the adjustment on the display parameter of the first one of the plurality of anatomical regions and propagated versions of the adjustment on the display parameter of remaining ones of the plurality of anatomical regions. In various aspects, the adjustment and the propagated versions of the adjustment can be in opposite directions. In other aspects, the adjustment and the propagated versions of the adjustment can be in a same direction. In various instances, the propagated versions of the adjustment can be generated via an adjustment coefficient, wherein the adjustment coefficient can be based on a current value of the display parameter of the first one of the plurality of anatomical regions and based on a target value of the display parameter of the first one of the plurality of anatomical regions indicated by the instruction. In various cases, the adjustment coefficient can be further based on a statistical intensity metric exhibited by whatever pixels or voxels make up the first one of the plurality of anatomical regions. In various aspects, the adjustment coefficient can be applied to the display parameter of the remaining ones of the plurality of anatomical regions in a weighted fashion. In various instances, the propagated versions of the adjustment can be generated via execution of a machine learning model on the adjustment indicated by the instruction. In various cases, the medical image can be a computed tomography scanned image, a magnetic resonance imaging scanned image, an ultrasound scanned image, an X-ray scanned image, a positron emission tomography scanned image, or a nuclear medicine scanned image. In various aspects, the display parameter can be a window width or a window level.

Such defined acts are not performed manually by humans. Indeed, neither the human mind nor a human with pen and paper can: visually render a scanned medical image on a computer screen; and electronically propagate, via an adjustment coefficient or via execution of a trained machine learning model, a window width or window level adjustment for one particular anatomical structure shown in the scanned medical image to other anatomical structures shown in the scanned medical image. Indeed, medical images are pixel arrays or voxel arrays that are captured by inherently-computerized, hardware-based scanners (e.g., CT scanners, X-ray scanners, MRI scanners). Such pixel arrays or voxel arrays cannot be created, displayed, or otherwise manipulated by the human mind without computers. Additionally, machine learning models (e.g., deep learning neural networks) are inherently computerized, software-based constructs that cannot be meaningfully trained or executed in any way by the human mind without computers. Furthermore, display parameters such as window width or window level are configurable software settings that control or govern what colors or shades are utilized to visually manifest the individual pixels or voxels of a scanned medical image. Such software settings simply cannot exist outside of a computerized environment. Accordingly, various embodiments described herein are inherently-computerized and cannot be implemented in any sensible, practical, or reasonable way without computers.

Moreover, various embodiments described herein can integrate into a practical application various teachings relating to the field of medical imaging. As described above, different types of anatomical structures can have better visibility or worse visibility at different display parameter values. Thus, using a single, global, or universal display parameter value for an entire medical image would be problematic. To address this issue, existing techniques utilize different or respective display parameter values for different anatomical structures (e.g., pixels or voxels that are labeled as bone tissue can have some particular window width, whereas pixels or voxels that are labeled as lung tissue can have some different window width). However, the present inventors realized that such existing techniques treat display parameter values across different anatomical structures as being wholly or totally independent of each other. Unfortunately, such total display parameter independence across anatomical structures can severely exacerbate time-consumption associated with making display parameter adjustments. For example, a medical professional can subjectively or idiosyncratically decide that visual inspection or interpretation of the medical image would be improved by changing the display parameter values of multiple (e.g., in some cases, dozens of) anatomical structures shown in a medical image. When existing techniques are implemented, the medical professional can be forced to spend on the order of several minutes sequentially tinkering with the display parameter values of those multiple anatomical structures (e.g., first tinkering with bone window width for dozens of seconds, then tinkering with lung window width for dozens of seconds, and then tinkering with liver window width for dozens of seconds, thereby yielding a total of several minutes of display parameter tinkering time). Such excessive time-consumption can be considered as undesirable.

Various embodiments described herein can address one or more of these technical problems. In particular, the present inventors realized that any given adjustment to the display parameter of a single anatomical structure in a medical image can be automatically propagated to the display parameter of any or all other anatomical structures in the medical image. In some cases, such propagation can be analytically performed via an adjustment coefficient (e.g., a weighted or unweighted difference or ratio between new and old values of the display parameter of the single anatomical structure). In other cases, such propagation can instead be performed in a probabilistic or stochastic fashion using a machine learning model that is trained to receive as input a requested adjustment to the display parameter of the single anatomical structure and to predict or infer as output commensurate or related adjustments to the display parameter of any or all other anatomical structures. In any of such situations, various embodiments described herein can be considered as treating display parameter values across different anatomical structures in an interdependent or intertwined fashion, rather than in a wholly independent or isolated fashion. For example, a medical professional can subjectively or idiosyncratically decide that visual inspection or interpretation of a medical image would be improved by changing the display parameter values of multiple (e.g., in some cases, dozens of) anatomical structures shown in a medical image. When various embodiments described herein are implemented, the medical professional need only spend time tinkering with the display parameter value of a single one of those multiple anatomical structures, and such tinkering can be automatically propagated to the display parameter values of the remaining anatomical structures (e.g., the medical professional can tinker with bone window width for dozens of seconds, but such tinkering can be propagated automatically to lung window width and liver window width without additional tinkering or time-expenditure by the medical professional). Thus, a total amount of time or effort spent by the medical professional on inspecting or interpreting the medical image can be reduced. In other words, propagation of display parameter adjustments across anatomical structures can be considered as a software tool that reduces the time required by a medical professional to determine a diagnosis or prognosis from medical image inspection.

Additionally, it must be emphasized how counter-intuitive various embodiments described herein are. As explained above, the animating principle of existing techniques is to treat display parameter values across different anatomical structures as wholly separate, independent, or isolated from each other. After all, such existing techniques were developed in response to prior techniques that applied global or universal display parameter values to entire medical images (e.g., that applied the exact same display parameter value to all pixels or voxels in a medical image, without regard to which anatomical structures those pixels or voxels belonged). Accordingly, various embodiments described herein, which treat display parameter values across different anatomical structures as being interdependent but not identical, would have been considered as backtracking, as a step in the wrong direction, or otherwise as undoing of technological progress. In other words, because the very purpose of existing techniques was to avoid the pitfalls of global display parameters by treating display parameter values of different anatomical structures as being totally independent of each other, eliminating such total independence would have been utterly antithetical to such existing techniques and would thus not even have been entertained as a possibility by those of ordinary skill in the art. Indeed, existing techniques considered display parameter independence across different anatomical structures to be a benefit rather than a bug (e.g., so that the display parameter value of each given anatomical structure can be independently optimized without negatively affecting the display parameter values of other anatomical structures). Thus, making display parameter values interdependent (but not necessarily identical) across anatomical structures would have been considered as diametrically opposed to or counter-productive with respect to existing techniques. Accordingly, various embodiments described herein can be considered as a clever, unusual, or surprising way of rendering medical images on electronic displays, when considered against the backdrop of existing techniques.

For at least these reasons, various embodiments described herein certainly constitute a tangible and concrete technical improvement, technical effect, or technical advantage in the field of medical imaging. Accordingly, such embodiments clearly qualify as useful and practical applications of computers.

Furthermore, various embodiments described herein can control real-world tangible devices based on the disclosed teachings. For example, various embodiments described herein can manipulate a real-world computer screen so to as visually render real-world medical images for visual inspection by real-world medical professionals.

It should be appreciated that the herein figures and description provide non-limiting examples of various embodiments and are not necessarily drawn to scale.

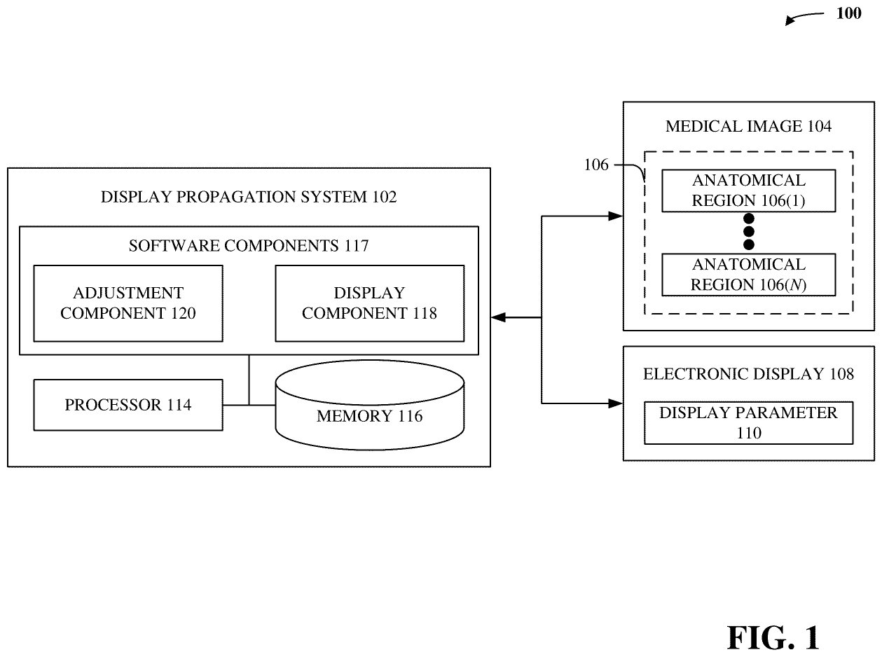

FIG. 1 illustrates a block diagram of an example, non-limiting system 100 that can facilitate region-wise propagation of display parameter adjustments in accordance with one or more embodiments described herein. As shown, a display propagation system 102 can be electronically integrated, via any suitable wired or wireless electronic connections, with a medical image 104 or with an electronic display 108.

In various embodiments, the medical image 104 can exhibit any suitable format, size, or dimensionality. As a non-limiting example, the medical image 104 can be an x-by-y array of pixels, for any suitable positive integers x and y. As another non-limiting example, the medical image 104 can be an x-by-y-by-z array of voxels, for any suitable positive integers x, y, and z. In various instances, the medical image 104 can be captured or otherwise generated by any suitable medical imaging scanner, equipment, or modality. As a non-limiting example, the medical image 104 can be captured or generated by an X-ray scanner. As another non-limiting example, the medical image 104 can be captured or generated by a CT scanner. As yet another non-limiting example, the medical image 104 can be captured or generated by an MRI scanner. As even another non-limiting example, the medical image 104 can be captured or generated by an ultrasound scanner. As still another non-limiting example, the medical image 104 can be captured or generated by a PET scanner. As another non-limiting example, the medical image 104 can be captured or generated by an NM scanner.

In any case, the medical image 104 can visually depict or illustrate a plurality of anatomical regions 106 of any suitable medical patient. In various aspects, the plurality of anatomical regions 106 can include n regions for any suitable positive integer n>1: an anatomical region 106(1) to an anatomical region 106(n). In various instances, each of the plurality of anatomical regions 106 can be any suitable distinct or unique type of anatomical, biological, or bodily structure of the medical patient. As a non-limiting example, any of the plurality of anatomical regions 106 can be any suitable organ (e.g., heart, lung, brain, eye, liver, kidney, intestine) or portion thereof of the medical patient. As another non-limiting example, any of the plurality of anatomical regions 106 can be any suitable tissue (e.g., adipose tissue, calcified tissue, cancerous tissue) or portion thereof of the medical patient. As yet another non-limiting example, any of the plurality of anatomical regions 106 can be any suitable bodily fluid (e.g., blood, bile, spinal fluid, water) or portion thereof of the medical patient. As even another non-limiting example, any of the plurality of anatomical regions 106 can be any suitable body cavity (e.g., abdominal cavity, nasal cavity, ear canal) or portion thereof of the medical patient. As still another non-limiting example, any of the plurality of anatomical regions 106 can be any suitable medical hardware (e.g., pacemaker, stent, vertebral screw, prosthesis) or portion thereof implanted in or on the medical patient.

In various instances, the medical image 104 can have undergone any suitable image reconstruction techniques, such as filtered back projection. Likewise, in various cases, the medical image 104 can have undergone any other suitable pre-processing or post-processing techniques, such as reorientation, denoising, or resolution enhancement. As a non-limiting example, any suitable type of anatomical segmentation or anatomical localization technique can be performed on the medical image 104, such that respective intra-image positions or locations of the plurality of anatomical regions 106 can be known. In other words, such anatomical segmentation or localization can reveal or identify which specific pixels or voxels of the medical image 104 belong to, make up, form, or otherwise constitute respective ones of the plurality of anatomical regions 106. In still other words, each pixel or voxel of the medical image 104 can be assigned a respective label that indicates or specifies which particular one (if any) of the plurality of anatomical regions 106 that pixel or voxels belongs to. In various aspects, the plurality of anatomical regions 106 can be disjoint, such that no pixel or voxel is assigned to more than one of the plurality of anatomical regions 106. It should be understood or otherwise appreciated that one anatomical region within the plurality of anatomical regions 106 can be considered as a background or catch-all region or category.

In various embodiments, the electronic display 108 can be any suitable type of computing or computerized device that can visually or visibly render image data, so that such image data can be seen or viewed by a user. As a non-limiting example, the electronic display 108 can be any suitable computer screen or computer monitor, such as a liquid crystal display (LCD), a plasma display, a cathode ray tube display, or an organic light emitting diode (OLED) display. As another non-limiting example, the electronic display 108 can be any suitable type of computerized image projector which can visually project (e.g., via optical lenses) image data onto a canvas, backstop, or other display surface or display medium (e.g., holographic medium).

In any case, the electronic display 108 can have, possess, or otherwise be associated with a display parameter 110. In various aspects, the display parameter 110 can be any suitable selectable or configurable software setting which can control, govern, dictate, affect, or otherwise influence how the electronic display 108 visually or visibly renders image data. In other words, the display parameter 110 can be considered as a variable which can take on scalar values sourced or chosen from any suitable domain within the real numbers (e.g., within R), and the specific scalar value that is assigned to that variable at any given time can control some visually perceptible quality (e.g., colors, shades, brightness, contrast) that the electronic display 108 uses to render image data.

As some non-limiting examples, the display parameter 110 can be window width or window level. Recall that, in various medical contexts, each pixel or voxel that is contained within any given collection of image data can be considered as exhibiting a respective intensity value (also referred to as a respective Hounsfield unit value), and such intensity value can be considered as conveying how dense whatever object that was located at or captured by that pixel or voxel is. For instance, pixels or voxels that represent air often exhibit Hounsfield unit values of about −1000; pixels or voxels that represent fat tissue often exhibit Hounsfield unit values of about −100; pixels or voxels that represent water often exhibit Hounsfield unit values of about 0; pixels or voxels that represent soft tissue often exhibit Hounsfield unit values of about 50; pixels or voxels that represent bone tissue often exhibit Hounsfield unit values of about 400; and pixels or voxels that represent metal often exhibit Hounsfield unit values of about 1000. In various aspects, window width and window level can be considered as software settings that control or govern which specific Hounsfield unit values are visualized by which specific shades of white, grey, or black. More specifically, there can be an absolute range of Hounsfield unit values that spans from a minimum-possible value (which can be denoted as Hₘᵢₙ) to a maximum-possible value (which can be denoted as Hₘₐₓ). Within this absolute range, a contiguous sub-interval of Hounsfield unit values can be defined that spans from some lower-bound value (which can be denoted as H_{lower}≥Hₘᵢₙ) to some upper-bound value (which can be denoted as Hᵤₚₚₑᵣ≤Hₘₐₓ). In other words, the absolute range can be denoted as [Hₘᵢₙ, Hₘₐₓ], and the contiguous sub-interval can be denoted as [H_{lower}, Hᵤₚₚₑᵣ] where Hₘᵢₙ≤H_{lower}<Hᵤₚₚₑᵣ≤Hₘₐₓ. In various aspects, any pixel or voxel whose Hounsfield unit value is less than H_{lower} can be visually represented by black, any pixel or voxel whose Hounsfield unit value is greater than Hᵤₚₚₑᵣ can be visually represented by white, and any pixel or voxel whose Hounsfield unit value is greater than H_{lower} but less than Hᵤₚₚₑᵣ can be represented by a respective shade of grey (e.g., where Hounsfield unit values closer to Hᵤₚₚₑᵣ can be visually represented by progressively lighter shades of grey, and where Hounsfield unit values closer to H_{lower} can be visually represented by progressively darker shades of grey). In such scenario, window width can be considered as being the width or size of [H_{lower}, Hᵤₚₚₑᵣ] (e.g., window width can be determined by subtracting H_{lower} from Hᵤₚₚₑᵣ). In contrast, window level can be considered as the midpoint or center of [H_{lower}, Hᵤₚₚₑᵣ] (e.g., window level can be determined by taking the arithmetic average of Hᵤₚₚₑᵣ and H_{lower}). Accordingly, increasing window width (e.g., widening [H_{lower}, Hᵤₚₚₑᵣ]) can have the effect of decreasing visual contrast within rendered image data, whereas decreasing window width (e.g., narrowing [H_{lower}, Hᵤₚₚₑᵣ]) can instead have the effect of increasing visual contrast within rendered image data. Additionally, increasing window level (e.g., shifting the center of [H_{lower}, Hᵤₚₚₑᵣ] more toward Hₘₐₓ) can have the effect of decreasing visual brightness of rendered image data, whereas decreasing window level (e.g., shifting the center of [H_{lower}, Hᵤₚₚₑᵣ] more toward Hₘᵢₙ) can instead have the effect of increasing visual brightness of rendered image data.

In any case, it can be desired to visually render the medical image 104 on the electronic display 108. In various instances, the display propagation system 112 can facilitate such visual rendition as described herein.

In various embodiments, the display propagation system 102 can comprise a processor 114 (e.g., computer processing unit, microprocessor) and a non-transitory computer-readable memory 116 that is operably or operatively or communicatively connected or coupled to the processor 114. The non-transitory computer-readable memory 116 can store computer-executable instructions which, upon execution by the processor 114, can cause the processor 114 or other components of the display propagation system 102 (e.g., display component 118, adjustment component 120) to perform one or more acts. In various embodiments, the non-transitory computer-readable memory 116 can store computer-executable components (e.g., display component 118, adjustment component 120), and the processor 114 can execute the computer-executable components.

In various embodiments, the display propagation system 102 can electronically access or otherwise electronically communicate in any suitable fashion with the electronic display 108. Accordingly, the display propagation system 102 can electronically transmit any suitable electronic data to the electronic display 108, and the electronic display 108 can likewise electronically transmit any suitable electronic data to the display propagation system 102. Accordingly, any components of the display propagation system 102 can interact with, communicate with, or otherwise manipulate the electronic display 108.

In various aspects, the display propagation system 102 can electronically access the medical image 104. That is, the display propagation system 102 can electronically receive, electronically retrieve, or otherwise electronically obtain the medical image 104, from any suitable electronic source, database, or computerized workstation. In some situations, the display propagation system 102 can receive, retrieve, or obtain the medical image 104 from whatever medical imaging scanner, modality, or equipment generated, created, or captured the medical image 104. In any case, any components of the display propagation system 102 can interact with, control, edit, or otherwise manipulate the medical image 104.

In various embodiments, the display propagation system 102 can comprise a display component 118. In various aspects, the display component 118 can, as described herein, cause the electronic display 108 to visually render the medical image 104 using values of the display parameter 110 that respectively correspond to the plurality of anatomical regions 106.

In various embodiments, the display propagation system 102 can comprise an adjustment component 120. In various instances, the adjustment component 120 can, as described herein, receive a user-supplied display parameter adjustment for one of the plurality of anatomical regions 106 and can implement not only that user-supplied display parameter adjustment for that one anatomical region but also propagated versions of that user-supplied display parameter adjustment for remaining ones of the plurality of anatomical regions 106.

Note that, in various instances, the display component 118 and the adjustment component 120 can collectively be considered as being one or more software components 117 of the display propagation system 102. In various aspects, it should be appreciated that the one or more software components 117 are described primarily herein as comprising two components (e.g., the display component 118 and the adjustment component 120) for ease of explanation and illustration. However, the one or more software components 117 are not limited to being implemented as exactly such two components in every embodiment. Indeed, in some embodiments, the functionalities described herein of such two components can be combined in any suitable fashions, so as to be implemented in or by fewer than two components (e.g., in some cases, a single component can perform all of the functionalities that are described herein with respect to the display component 118 and the adjustment component 120). In other embodiments, the functionalities described herein of such two components can instead be distributed, separated, split, or fragmented in any suitable fashions, so as to be implemented in or by more than two components (e.g., two or more components can facilitate the functionalities that are performable by the display component 118; two or more components can facilitate the functionalities that are performable by the adjustment component 120).

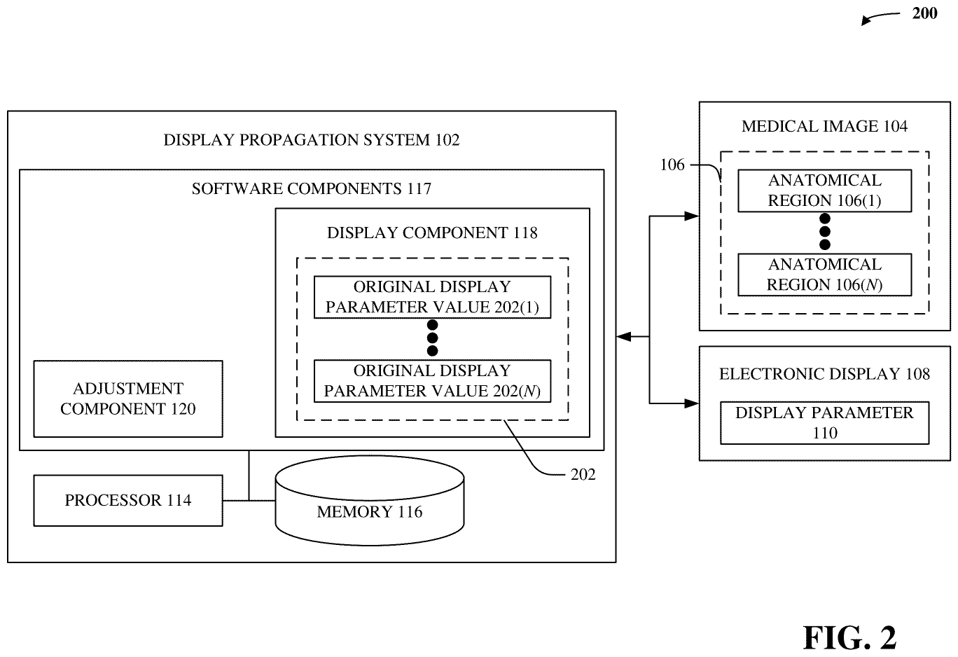

FIG. 2 illustrates a block diagram of an example, non-limiting system 200 including a plurality of original display parameter values that can facilitate region-wise propagation of display parameter adjustments in accordance with one or more embodiments described herein. As shown, the system 200 can, in various cases, include the same components as the system 100, and can further include a plurality of original display parameter values 202.

In various embodiments, the display component 118 can electronically instruct, electronically command, or otherwise electronically cause the electronic display 108 to visually render the medical image 104 using the plurality of original display parameter values 202. In various aspects, the plurality of original display parameter values 202 can respectively correspond (e.g., in one-to-one fashion) with the plurality of anatomical regions 106. Since the plurality of anatomical regions 106 can have n regions, the plurality of original display parameter values 202 can likewise have n values: an original display parameter value 202(1) to an original display parameter value 202(n). In various instances, each of the plurality of original display parameter values 202 can be a real-valued scalar which the electronic display 108 can assign to the display parameter 110 so as to visually render pixels or voxels belonging to a respective one of the plurality of anatomical regions 106. As a non-limiting example, the original display parameter value 202(1) can correspond to the anatomical region 106(1). Thus, for visual rendition of whichever pixels or voxels make up, constitute, or are labeled with the anatomical region 106(1), the electronic display 108 can assign the original display parameter value 202(1) to the display parameter 110. As another non-limiting example, the original display parameter value 202(n) can correspond to the anatomical region 106(n). So, for visual rendition of whichever pixels or voxels make up, constitute, or are labeled with the anatomical region 106(n), the electronic display 108 can assign the original display parameter value 202(n) to the display parameter 110. In other words, different anatomical regions of the medical image 104 can be visually rendered using different or respective values of the display parameter 110 (e.g., different anatomical regions can be visualized with different or respective window widths; different anatomical regions can be visualized with different or respective window levels).

In various instances, the display component 118 can determine, calculate, or identify the plurality of original display parameter values 202 in any suitable fashion. As a non-limiting example, the plurality of original display parameter values 202 can be any suitable default values that are statistically or empirically associated with the plurality of anatomical regions 106 (e.g., a study or survey can have revealed that a majority of medical professionals set the display parameter 110 to the original display parameter value 202(1) when visually inspecting an organ that matches or is of the same biological type as the anatomical region 106(1); a study or survey can have asked medical professionals what specific value they set the display parameter 110 to when visually inspecting an organ that matches or is of the same biological type as the anatomical region 106(1), and the original display parameter value 202(1) can be equal to an average or mean of the medical professionals' responses). As another non-limiting example, the plurality of original display parameter values 202 can be whatever values that were most recently implemented by the electronic display 108 for visualizing the plurality of anatomical regions 106 (e.g., the electronic display 108 can have recently rendered some other medical image that depicted an organ matching or otherwise of the same type as the anatomical region 106(1), and whatever value of the display parameter 110 that the electronic display 108 used to visually render that matching or same-type organ can be referred to as the original display parameter value 202(1)).

In any case, the display component 118 can cause the electronic display 108 to visually render the medical image 104, such that the medical image 104 can be visually inspected or interpreted by a medical professional for diagnostic or prognostic purposes.

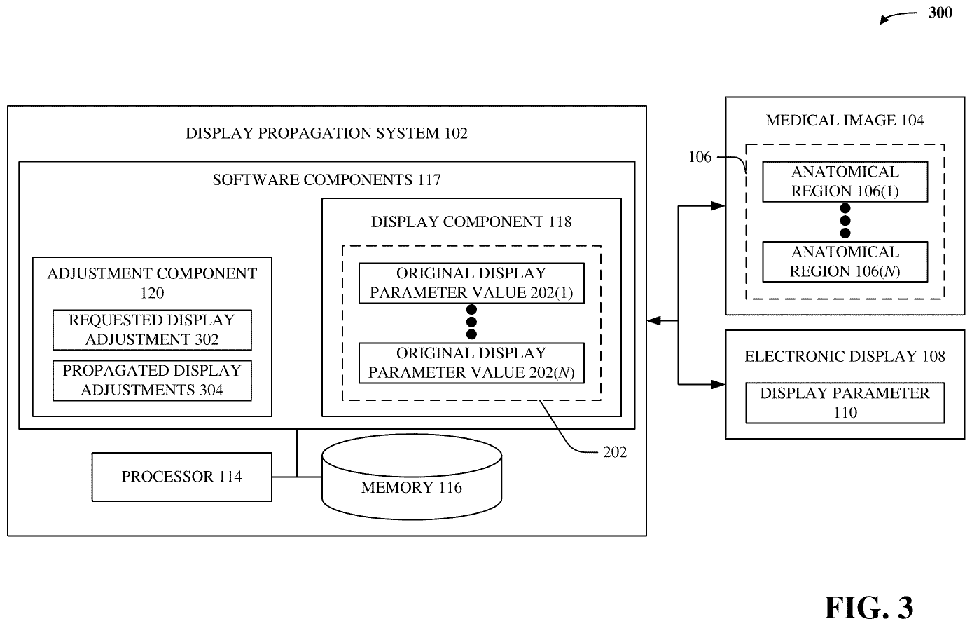

FIG. 3 illustrates a block diagram of an example, non-limiting system 300 including a requested display adjustment and a set of propagated display adjustments that can facilitate region-wise propagation of display parameter adjustments in accordance with one or more embodiments described herein. As shown, the system 300 can, in some cases, comprise the same components as the system 200, and can further comprise a requested display adjustment 302 or a set of propagated display adjustments 304.

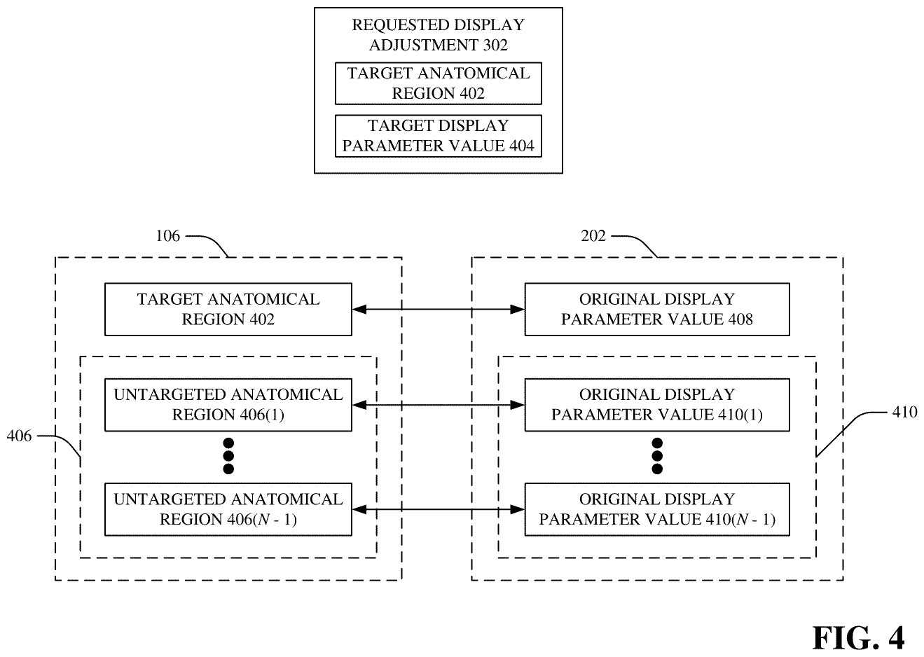

In various embodiments, the adjustment component 120 can electronically access in any suitable fashion (e.g., receive, retrieve, or obtain from any suitable electronic source) the requested display adjustment 302. In some aspects, the requested display adjustment 302 can be provided by a medical professional interacting with any suitable human-computer interface device associated with the electronic display 108. Non-limiting examples of such human-computer interface device can include: a touchscreen of the electronic display 108; a keyboard, keypad, or other button panel of the electronic display 108; a computer mouse or joystick of the electronic display 108; or a voice command system of the electronic display 108. In other aspects, the requested display adjustment 302 can be provided by any other suitable computerized device that is separate or remote from the display propagation system 102. As a non-limiting example, the requested display adjustment 302 can be provided by an artificially intelligent computerized agent whose task is to analyze or otherwise interact with the medical image 104. In various instances, the requested display adjustment 302 can be any suitable electronic data that specifies, represents, or otherwise conveys that the medical professional desires or wants at least one of the plurality of original display parameter values 202 to be changed to some new value (e.g., to enhance or improve visual inspection of the medical image 104 by the medical professional). In various cases, the adjustment component 120 can electronically implement such change. However, the adjustment component 120 can also electronically implement a version of such change on at least one remaining, other, or unspecified one of the plurality of original display parameter values 202, and such other changes can be referred to as the set of propagated display adjustments 304. Non-limiting aspects are described with respect to FIGS. 4-8.

FIGS. 4-8 illustrate example, non-limiting block diagrams showing how the set of propagated display adjustments 304 can be created based on the requested display adjustment 302 in accordance with one or more embodiments described herein.

First, consider FIG. 4. In various embodiments, the requested display adjustment 302 can contain, include, or specify a target anatomical region 402 and a target display parameter value 404. In various aspects, the target anatomical region 402 can be any one of the plurality of anatomical regions 106. In various instances, the target display parameter value 404 can be a scalar value which the medical professional desires or wants to be assigned to the display parameter 110 for visual rendition of whatever pixels or voxels make up the target anatomical region 402.

Note that the plurality of anatomical regions 106 can be considered as being partitioned into the target anatomical region 402 and a set of untargeted anatomical regions 406, where the set of untargeted anatomical regions 406 can be considered as being all the other or remaining ones of the plurality of anatomical regions 106. Thus, the set of untargeted anatomical regions 406 can contain a total of n−1 regions: an untargeted anatomical region 406(1) to an untargeted anatomical region 406(n−1). In various cases, whichever one of the plurality of original display parameter values 202 corresponds to the target anatomical region 402 can be referred to as an original display parameter value 408. In various aspects, all the remaining ones of the plurality of original display parameter values 202 can be referred to as a set of original display parameter values 410. So, the set of original display parameter values 410 can contain a total of n−1 values: an original display parameter value 410(1) to an original display parameter value 410(n−1). Note that the set of original display parameter values 410 can respectively correspond (e.g., in one-to-one fashion) with the set of untargeted anatomical regions 406 (e.g., the original display parameter value 410(1) can be whatever value that the electronic display 108 is currently or presently using to visually render the pixels or voxels that make up the untargeted anatomical region 406(1); the original display parameter value 410(n−1) can be whatever value that the electronic display 108 is currently or presently using to visually render the pixels or voxels that make up the untargeted anatomical region 406(n−1)).

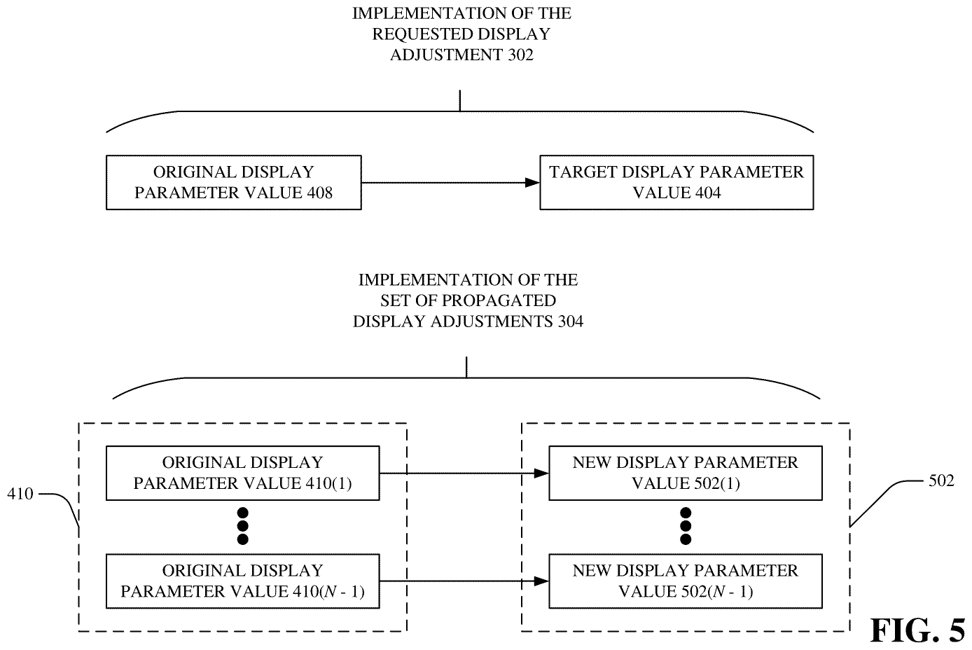

Next, consider FIG. 5. In various embodiments, the adjustment component 120 can electronically implement the requested display adjustment 302. In other words, the adjustment component 120 can electronically instruct, electronically command, or otherwise electronically cause the electronic display 108 to switch or edit the original display parameter value 408 to the target display parameter value 404. In still other words, the electronic display 108 can be considered as: no longer visually rendering the pixels or voxels that make up the target anatomical region 402 by assigning the original display parameter value 408 to the display parameter 110; and as instead visually rendering the pixels or voxels that make up the target anatomical region 402 by assigning the target display parameter value 404 to the display parameter 110. Such implementation of the requested display adjustment 302 can change a visually perceptible quality (e.g., color, brightness, contrast) of the target anatomical region 402 as visualized by the electronic display 108.

In various aspects, the adjustment component 120 can also electronically implement the set of propagated display adjustments 304. In various instances, the set of propagated display adjustments 304 can contain a total of n−1 adjustments respectively corresponding (e.g., in one-to-one fashion) to the set of untargeted anatomical regions 406. That is, the adjustment component 120 can respond to the requested display adjustment 302 by not only changing the value of the display parameter 110 that is used for the pixels or voxels that make up the target anatomical region 402, but also by changing the values of the display parameter 110 that are used for the pixels or voxels that make up the set of untargeted anatomical regions 406.

As a non-limiting example, for a first one of the set of propagated display adjustments 304, the adjustment component 120 can electronically instruct, electronically command, or otherwise electronically cause the electronic display 108 to switch or edit the original display parameter value 410(1) to a new display parameter value 502(1). In other words, the electronic display 108 can be considered as: no longer visually rendering the pixels or voxels that make up the untargeted anatomical region 406(1) by assigning the original display parameter value 410(1) to the display parameter 110; and as instead visually rendering the pixels or voxels that make up the untargeted anatomical region 406(1) by assigning the new display parameter value 502(1) to the display parameter 110. This can change a visually perceptible quality (e.g., color, brightness, contrast) of the untargeted anatomical region 406(1) as visualized by the electronic display 108, even though no such change was requested by the medical professional.

As another non-limiting example, for an (n−1)-th one of the set of propagated display adjustments 304, the adjustment component 120 can electronically instruct, electronically command, or otherwise electronically cause the electronic display 108 to switch or edit the original display parameter value 410(n−1) to a new display parameter value 502(n−1). In other words, the electronic display 108 can be considered as: no longer visually rendering the pixels or voxels that make up the untargeted anatomical region 406(n−1) by assigning the original display parameter value 410(n−1) to the display parameter 110; and as instead visually rendering the pixels or voxels that make up the untargeted anatomical region 406(n−1) by assigning the new display parameter value 502(n−1) to the display parameter 110. This can change a visually perceptible quality (e.g., color, brightness, contrast) of the untargeted anatomical region 406(n−1) as visualized by the electronic display 108, even though no such change was requested by the medical professional.

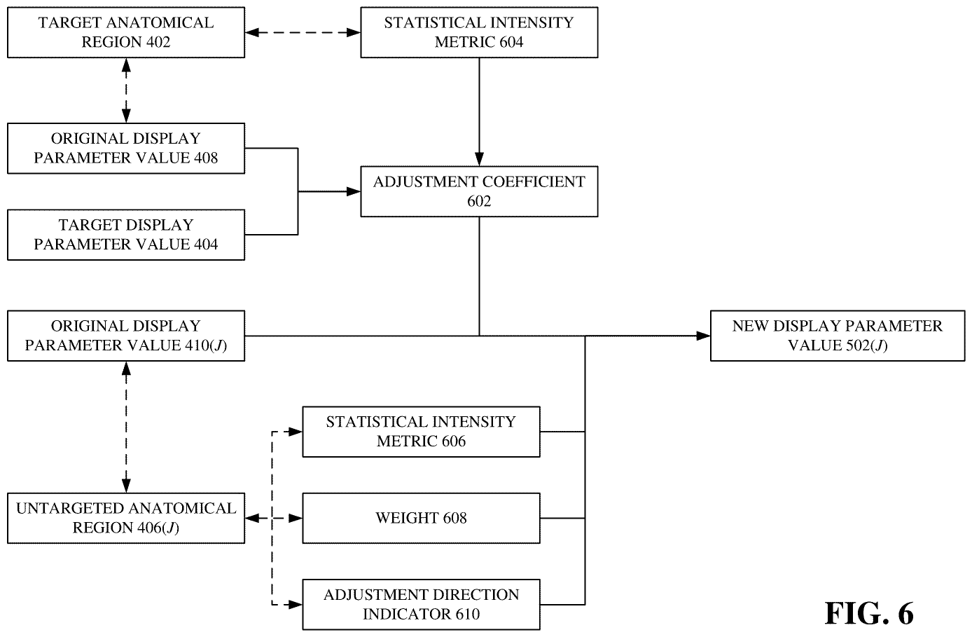

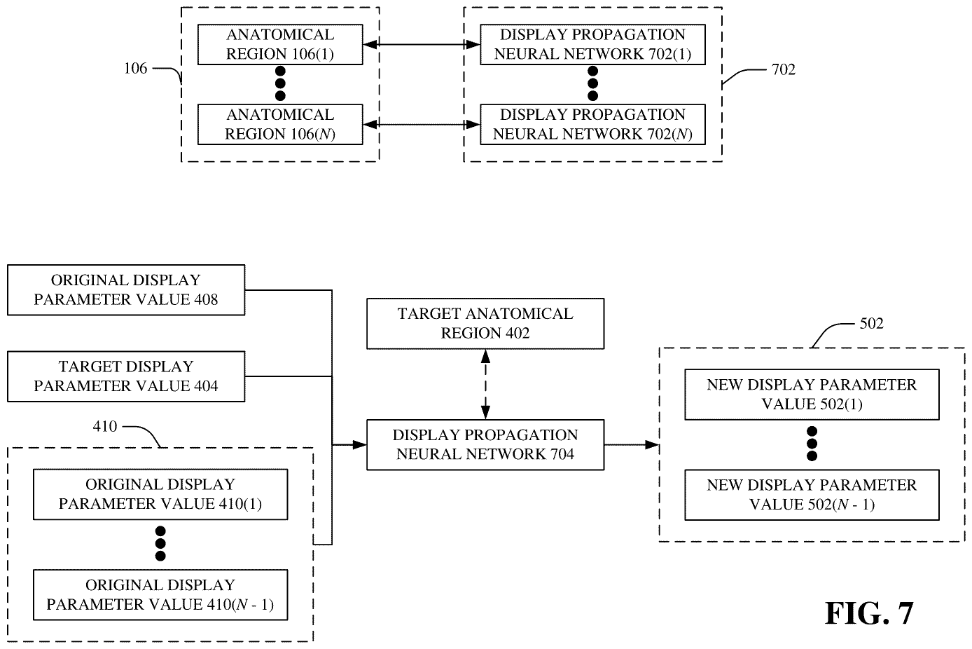

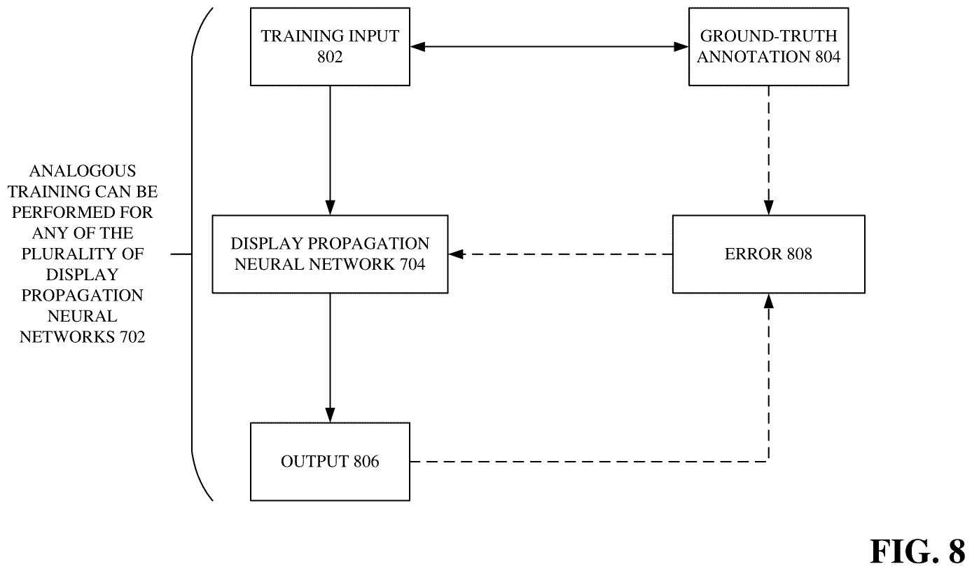

Note that the new display parameter value 502(1) to the new display parameter value 502(n−1) can collectively be considered as forming a set of new display parameter values 502. In various aspects, the adjustment component 120 can compute, calculate, or otherwise determine the set of new display parameter values 502 based on the requested display adjustment 302. In some cases, such computation, calculation, or determination can involve leveraging an adjustment coefficient derived from the requested display adjustment 302, such as described with respect to FIG. 6. In other cases, such computation, calculation, or determination can involve execution of a trained neural network on the requested display adjustment 302, such as described with respect to FIGS. 7-8.

Now, consider FIG. 6. In various embodiments, any one of the set of untargeted anatomical regions 406 can be selected. Such selected region can be referred to as an untargeted anatomical region 406(j), for any suitable positive integer j<n. In various aspects, whatever one of the set of original display parameter values 410 that corresponds to the untargeted anatomical region 406(j) can be referred to as an original display parameter value 410(j). Likewise, whatever one of the set of new display parameter values 502 that corresponds to the untargeted anatomical region 406(j) can be referred to as a new display parameter value 502(j). In various instances, the adjustment component 120 can compute or calculate the new display parameter value 502(j) by leveraging an adjustment coefficient 602.

In various cases, the adjustment coefficient 602 can be any suitable real-valued scalar whose magnitude is based on the original display parameter value 408 and the target display parameter value 404. As a non-limiting example, the adjustment coefficient 602 can be equal to an arithmetic difference between the target display parameter value 404 and the original display parameter value 408 (e.g., can be equal to the difference obtained by subtracting the original display parameter value 408 from the target display parameter value 404). As another non-limiting example, the adjustment coefficient 602 can be equal to a ratio between the target display parameter value 404 and the original display parameter value 408 (e.g., the target display parameter value 404 can serve as the numerator of such ratio, and the original display parameter value 408 can serve as the denominator of such ratio).

In some situations, the adjustment coefficient 602 can be further based on a statistical intensity metric 604 associated with the target anatomical region 402. In various aspects, the statistical intensity metric 604 can be any suitable statistical measurement or composition of statistical measurements that is exhibited by the pixels or voxels that make up the target anatomical region 402. As a non-limiting example, the statistical intensity metric 604 can be equal to an average intensity (e.g., average Hounsfield unit value) that is exhibited by the pixels or voxels of the target anatomical region 402. As another non-limiting example, the statistical intensity metric 604 can be equal to a median intensity (e.g., median Hounsfield unit value) that is exhibited by the pixels or voxels of the target anatomical region 402. As still another non-limiting example, the statistical intensity metric 604 can be equal to an arithmetic difference between any two percentile intensities (e.g., any two percentile Hounsfield unit values) that are exhibited by the pixels or voxels of the target anatomical region 402 (e.g., difference between a 90-th percentile intensity and a 10-th percentile intensity exhibited by the pixels or voxels of the target anatomical region 402; difference between a 75-th percentile intensity and a 25-th percentile intensity exhibited by the pixels or voxels of the target anatomical region 402). In any of such cases, the adjustment coefficient 602 can be obtained by dividing: an arithmetic difference or ratio between the target display parameter value 404 and the original display parameter value 408; by the statistical intensity metric 604.

No matter how the adjustment coefficient 602 is derived, the new display parameter value 502(j) can be computed or calculated by mathematically applying (e.g., via any suitable mathematical operation) the adjustment coefficient 602 to the original display parameter value 410(j). As a non-limiting example, suppose that the adjustment coefficient 602 is based on an arithmetic difference between the target display parameter value 404 and the original display parameter value 408. In such case, the adjustment component 120 can mathematically add the adjustment coefficient 602 to the original display parameter value 410(j), and the result of such addition can be the new display parameter value 502(j). As another non-limiting example, suppose that the adjustment coefficient 602 is based on a ratio between the target display parameter value 404 and the original display parameter value 408. In such case, the adjustment component 120 can mathematically multiply the adjustment coefficient 602 by the original display parameter value 410(j), and the result of such multiplication can be the new display parameter value 502(j).

In situations where the adjustment coefficient 602 is based on the statistical intensity metric 604, the adjustment component 120 can mathematically apply the adjustment coefficient 602 to the original display parameter value 410(j) in conjunction with a statistical intensity metric 606 that corresponds to the untargeted anatomical region 406(j). In various aspects, the statistical intensity metric 606 can be of the same or identical type as the statistical intensity metric 604, but can be exhibited by the pixels or voxels of the untargeted anatomical region 406(j) rather than by the pixels or voxels of the target anatomical region 402. As a non-limiting example, suppose that the statistical intensity metric 604 is equal to an average intensity exhibited by the pixels or voxels of the target anatomical region 402. In such case, the statistical intensity metric 606 can be equal to whatever average intensity is exhibited by the pixels or voxels of the untargeted anatomical region 406(j). As another non-limiting example, suppose that the statistical intensity metric 604 is equal to a median intensity exhibited by the pixels or voxels of the target anatomical region 402. In such case, the statistical intensity metric 606 can be equal to whatever median intensity is exhibited by the pixels or voxels of the untargeted anatomical region 406(j). As even another non-limiting example, suppose that the statistical intensity metric 604 is equal to an arithmetic difference between a 90-th percentile intensity and a 10-th percentile intensity exhibited by the pixels or voxels of the target anatomical region 402. In such case, the statistical intensity metric 606 can be equal to an arithmetic difference between a 90-th percentile intensity and a 10-th percentile intensity exhibited by the pixels or voxels of the untargeted anatomical region 406(j). In any of such instances, the adjustment component 120 can multiply the adjustment coefficient 602 by the statistical intensity metric 606, prior to mathematically applying (e.g., prior to adding to or multiplying) the adjustment coefficient 602 to the original display parameter value 410(j).

In various aspects, the untargeted anatomical region 406(j) can correspond to a weight 608. In various instances, the weight 608 can be any suitable real-valued scalar that indicates how much or how little the pixels or voxels of the untargeted anatomical region 406(j) should be affected by a visualization change in the pixels or voxels of the target anatomical region 402 (e.g., if the weight 608 has an absolute value that is greater than 1, this can indicate that the untargeted anatomical region 406(j) is or should be more strongly affected by visualization changes in the target anatomical region 402; conversely, if the weight 608 has an absolute value that is less than 1, this can indicate that the untargeted anatomical region 406(j) is or should be more weakly affected by visualization changes in the target anatomical region 402). Note that the absolute value or magnitude of the weight 608 can be chosen, selected, or otherwise determined in any suitable fashion (e.g., the weight 608 can be established by user-selected preferences; the weight 608 can be empirically computed by studying or surveying how the medical community usually or normally changes the visualization of the untargeted anatomical region 406(j) when also changing the visualization of the target anatomical region 402). In any case, the adjustment component 120 can multiply or scale the adjustment coefficient 602 by the weight 608, prior to mathematically applying (e.g., prior to adding to or multiplying) the adjustment coefficient 602 to the original display parameter value 410(j).

In various aspects, the untargeted anatomical region 406(j) can correspond to an adjustment direction indicator 610. In various instances, the adjustment direction indicator 610 can be any suitable electronic data exhibiting any suitable format, size, or dimensionality (e.g., can be one or more scalars, one or more vectors, one or more matrices, one or more tensors, one or more character strings, or any suitable combination thereof) that indicates whether visual rendition of the untargeted anatomical region 406(j) should be changed in a same direction as, or instead in a different direction than, visual rendition of the target anatomical region 402.

As a non-limiting example, suppose that the adjustment direction indicator 610 indicates or specifies that display parameter adjustments made to the untargeted anatomical region 406(j) should be in a same direction as display parameter adjustments made to the target anatomical region 402. In such case, the adjustment component 120 can add (if the adjustment coefficient 602 is based on an arithmetic difference between the target display parameter value 404 and the original display parameter value 408) or multiply (if the adjustment coefficient 602 is based on a ratio between the target display parameter value 404 and the original display parameter value 408) the adjustment coefficient 602 (after the adjustment coefficient 602 is scaled or augmented by the weight 608 or the statistical intensity metric 606, as appropriate) to or by the original display parameter value 410(j). In such case, if the target display parameter value 404 is greater than the original display parameter value 408, such addition or multiplication (as appropriate) can cause the new display parameter value 502(j) to likewise be greater than the original display parameter value 410(j) (e.g., the original display parameter values of the target anatomical region 402 and the untargeted anatomical region 406(j) can have both been increased). Also in such case, if the target display parameter value 404 is lesser than the original display parameter value 408, such addition or multiplication (as appropriate) can cause the new display parameter value 502(j) to likewise be lesser than the original display parameter value 410(j) (e.g., the original display parameter values of the target anatomical region 402 and the untargeted anatomical region 406(j) can have both been decreased). Note that such same-directionality of display parameter adjustments can help to preserve a visual consistency between the target anatomical region 402 and the untargeted anatomical region 406(j), which can be desirable under some circumstances.

As another non-limiting example, suppose that the adjustment direction indicator 610 indicates or specifies that display parameter adjustments made to the untargeted anatomical region 406(j) should be in an opposite direction as display parameter adjustments made to the target anatomical region 402. In such case, the adjustment component 120 can subtract (if the adjustment coefficient 602 is based on an arithmetic difference between the target display parameter value 404 and the original display parameter value 408) or divide (if the adjustment coefficient 602 is based on a ratio between the target display parameter value 404 and the original display parameter value 408) the adjustment coefficient 602 (after the adjustment coefficient 602 is scaled or augmented by the weight 608 or the statistical intensity metric 606, as appropriate) from or by the original display parameter value 410(j). In such case, if the target display parameter value 404 is greater than the original display parameter value 408, such subtraction or division (as appropriate) can cause the new display parameter value 502(j) to instead be lesser than the original display parameter value 410(j) (e.g., the original display parameter value of the target anatomical region 402 can have been increased while that of the untargeted anatomical region 406(j) can be decreased). Also in such case, if the target display parameter value 404 is lesser than the original display parameter value 408, such subtraction or division (as appropriate) can cause the new display parameter value 502(j) to instead be greater than the original display parameter value 410(j) (e.g., the original display parameter value of the target anatomical region 402 can have been decreased while that of the untargeted anatomical region 406(j) can be increased). Note that such opposite-directionality of display parameter adjustments can help to enhance a visual contrast or distinction between the target anatomical region 402 and the untargeted anatomical region 406(j), which can be desirable under some circumstances.

In various aspects, the adjustment direction indicator 610 can be chosen, selected, or otherwise determined in any suitable fashion (e.g., the adjustment direction indicator 610 can be established by user-selected preferences; the adjustment direction indicator 610 can be empirically determined by studying or surveying how the medical community usually or normally changes the visualization of the untargeted anatomical region 406(j) when also changing the visualization of the target anatomical region 402).

As a non-limiting illustration of the concepts described with respect to FIG. 6, suppose that the target anatomical region 402 is liver tissue, the untargeted anatomical region 406(j) is lung tissue, the display parameter 110 is window width, the adjustment direction indicator 610 specifies same-directionality, and the statistical intensity metric 604 and statistical intensity metric 606 are differences between 90-th and 10-th percentile intensities. In some of such cases, the new display parameter value 502(j) can be computed using the following formula:

$${WW}_{lung \_ new} = {WW}_{lung \_ original} + {ω}_{lung \_ liver} {C}_{adjustment} ( {p}_{90 \_ lung} - {p}_{10 \_ lung} )$$

where WW_{lung_new} represents a new window width for lung tissue (e.g., 502(j)), where WW_{lung_original} represents an original window width for lung tissue (e.g., 410(j)), where @lung liver represents a weight showing how sensitive display adjustments for lung tissue are with respect to display adjustments for liver tissue (e.g., 608), where p_{90_lung}−p_{10_lung} represents a difference between a 90-th percentile intensity and a 10-th percentile intensity exhibited by the lung tissue (e.g., 606), where

$${C}_{adjustment} = \frac{{WW}_{liver \_ target} - {WW}_{liver \_ original}}{{p}_{90 \_ liver} - {p}_{10 \_ liver}}$$

represents the adjustment coefficient 602, where WW_{liver_target} represents a target window width for liver tissue (e.g., 404), where WW_{liver_original} represents an original window width for liver tissue (e.g., 408), and where p_{90_liver}−p_{10_liver} represents a difference between a 90-th percentile intensity and a 10-th percentile intensity exhibited by the liver tissue (e.g., 604). In others of such cases, the new display parameter value 502(j) can be computed using the following formula:

$${WW}_{lung \_ new} = {WW}_{lung \_ original} {ω}_{lung \_ liver} {C}_{adjustment} ( {p}_{90 \_ lung} - {p}_{10 \_ lung} )$$

where

$${C}_{adjustment} = \frac{{WW}_{liver \_ target}}{{WW}_{liver \_ original} ( {p}_{{90}_{liver}} - {p}_{{10}_{liver}} )} .$$

As another non-limiting illustration, suppose that the target anatomical region 402 is liver tissue, the untargeted anatomical region 406(j) is lung tissue, the display parameter 110 is window width, the adjustment direction indicator 610 specifies opposite-directionality, and the statistical intensity metric 604 and the statistical intensity metric 606 are differences between 90-th and 10-th percentile intensities. In some of such cases, the new display parameter value 502(j) can be computed using the following formula:

$${WW}_{lung \_ new} = {WW}_{lung \_ original} - {ω}_{lung \_ liver} {C}_{adjustment} ( {p}_{90 \_ lung} - {p}_{10 \_ lung} )$$

where

$${C}_{adjustment} = \frac{{WW}_{liver \_ target} - {WW}_{liver \_ original}}{{p}_{90 \_ liver} - {p}_{10 \_ liver}} .$$

In others of such cases, the new display parameter value 502(j) can be computed using the following formula:

$${WW}_{lung \_ new} = \frac{{WW}_{lung \_ original}}{{ω}_{lung \_ liver} {C}_{adjustment} ( {p}_{90 \_ lung} - {p}_{10 \_ lung} )}$$

where

$${C}_{adjustment} = \frac{{WW}_{liver \_ target}}{{WW}_{liver \_ original} ( {p}_{{90}_{liver}} - {p}_{{10}_{liver}} )} .$$

In various aspects, the adjustment component 120 can compute each of the set of new display parameter values 502 utilizing the adjustment coefficient 602 in accordance with FIG. 6 (e.g., using respective statistical intensity metrics, respective weights, or respective adjustment direction indicators).

Next, consider FIG. 7. Rather than utilizing the adjustment coefficient 602, the adjustment component 120 can instead compute the set of new display parameter values 502 by leveraging or utilizing a plurality of display propagation neural networks 702. In particular, the adjustment component 120 can electronically store, electronically maintain, electronically control, or otherwise electronically access the plurality of display propagation neural networks 702. In various aspects, the plurality of display propagation neural networks 702 can respectively correspond (e.g., in one-to-one fashion) to the plurality of anatomical regions 106. Since the plurality of anatomical regions 106 can include a total of n regions, the plurality of display propagation neural networks 702 can likewise include a total of n networks: a display propagation neural network 702(1) to a display propagation neural network 702(n). In various aspects, each of the plurality of display propagation neural networks 702 can exhibit any suitable deep learning internal architecture. Indeed, in various cases, each of the plurality of display propagation neural networks 702 can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers. In various cases, different ones of the plurality of display propagation neural networks 702 can exhibit the same or different internal architectures as each other.

In various aspects, each of the plurality of display propagation neural networks 702 can be configured to predict or infer display parameter adjustments for a remainder of the plurality of anatomical regions 106, when given a display parameter adjustment for a respective one of the plurality of anatomical regions 106. As a non-limiting example, the display propagation neural network 702(1) can correspond to the anatomical region 106(1). So, when given any particular display parameter adjustment that is performed on the pixels or voxels belonging to the anatomical region 106(1), the display propagation neural network 702(1) can predict or infer respective display parameter adjustments that should be made to the pixels or voxels of an anatomical region 106(2) (not shown) to the anatomical region 106(n). As another non-limiting example, the display propagation neural network 702(n) can correspond to the anatomical region 106(n). So, when given any particular display parameter adjustment that is performed on the pixels or voxels belonging to the anatomical region 106(n), the display propagation neural network 702(n) can predict or infer respective display parameter adjustments that should be made to the pixels or voxels of the anatomical region 106(1) to an anatomical region 106(n−1) (not shown).

In various embodiments, whichever one of the plurality of display propagation neural networks 702 that corresponds to the target anatomical region 402 can be referred to as a display propagation neural network 704. In various aspects, the adjustment component 120 can compute the set of new display parameter values 502, by executing the display propagation neural network 704. For instance, the adjustment component 120 can concatenate together the original display parameter value 408, the target display parameter value 404, and the set of original display parameter values 410 and can feed such concatenation to an input layer of the display propagation neural network 704. In various cases, such concatenation can complete a forward pass through one or more hidden layers of the display propagation neural network 704. In various aspects, an output layer of the display propagation neural network 704 can calculate the set of new display parameter values 502, based on hidden activation maps or feature maps produced by the one or more hidden layers during the forward pass. In other words, the display propagation neural network 704 can be considered as predicting or inferring how the display parameter value of each of the set of untargeted anatomical regions 406 should be increased or decreased, given how much the medical professional desires to increase or decrease the display parameter value of the target anatomical region 402.

In order for the display propagation neural network 704 to function accurately or reliably, it can first undergo training, such as described with respect to FIG. 8.

Consider FIG. 8, which non-limitingly illustrates how the display propagation neural network 704 can be trained in supervised fashion in accordance with various embodiments.

In various aspects, prior to beginning training, the trainable internal parameters (e.g., convolutional kernels, weight matrices, bias values) of the display propagation neural network 704 can be initialized in any suitable fashion (e.g., via random initialization) by the adjustment component 120.

In various embodiments, there can be a training input 802 and a ground-truth annotation 804. In various aspects, the training input 802 can be a concatenation of: a training original display parameter value of the target anatomical region 402; a training target display parameter value of the target anatomical region 402; and a set of training original display parameter values for the set of untargeted anatomical regions 406. In various instances, the ground-truth annotation 804 can be a set of new display parameter values for the set of untargeted anatomical regions 406 that are known or deemed to be accurate or correct when given the training input 802.

In various aspects, the adjustment component 120 can execute the display propagation neural network 704 on the training input 802, thereby causing the display propagation neural network 704 to produce an output 806. More specifically, the adjustment component 120 can feed the training input 802 to the input layer of the display propagation neural network 704, the training input 802 can complete a forward pass through the one or more hidden layers of the display propagation neural network 704, and the output layer of the display propagation neural network 704 can calculate the output 806 based on hidden activation maps or feature maps produced by the one or more hidden layers during the forward pass.

Note that the format, size, or dimensionality of the output 806 can be dictated by the number, arrangement, sizes, or other characteristics of the neurons, convolutional kernels, attention blocks, or other internal parameters of the output layer (or of any other layers) of the display propagation neural network 704. Accordingly, the output 806 can be forced to have any desired format, size, or dimensionality, by adding, removing, or otherwise adjusting characteristics of the output layer (or of any other layers) of the display propagation neural network 704. In particular, the output 806 can be forced to have the same format, size, or dimensionality as the ground-truth annotation 804. Accordingly, the output 806 can be considered as the predicted or inferred new display parameter values which the display propagation neural network 704 believes should be used to visualize the set of untargeted anatomical regions 406, when given the training input 802. In contrast, the ground-truth annotation 804 can be considered as the correct or accurate new display parameter values which are known or deemed to be used to visualize the set of untargeted anatomical regions 406 when given the training input 802. Note that, if the display propagation neural network 704 has so far undergone no or little training, then the output 806 can be highly inaccurate. In other words, the output 806 can be very different from the ground-truth annotation 804.

In various aspects, the adjustment component 120 can compute an error 808 (e.g., mean absolute error, mean squared error, cross-entropy error) between the output 806 and the ground-truth annotation 804. In various instances, the adjustment component 120 can incrementally update via backpropagation (e.g., stochastic gradient descent) the trainable internal parameters of the display propagation neural network 704 based on the error 808.

In various cases, such execution-and-update procedure can be repeated for any suitable number of training input-annotation pairs. This can ultimately cause the trainable internal parameters of the display propagation neural network 704 to become iteratively optimized for accurately propagating to the set of untargeted anatomical regions 406 display adjustments that are made to the target anatomical region 402. In various aspects, any suitable training batch sizes, any suitable error/loss functions, or any suitable training termination criteria can be utilized during such training.

Although the herein disclosure mainly describes the display propagation neural network 704 as being trained in supervised fashion, this is a mere non-limiting example for ease of explanation and illustration. In various embodiments, any other suitable training paradigms can be used to train the display propagation neural network 704, such as unsupervised training or reinforcement learning, any of which may be federated or unfederated. Furthermore, it should be understood or otherwise appreciated that any others of the plurality of display propagation neural networks 702 can be trained in analogous fashion as the display propagation neural network 704.

In any case, the adjustment component 120 can be considered as propagating respective versions of the requested display adjustment 302 (which the medical professional desires to be implemented for the target anatomical region 402) to each of the set of untargeted anatomical regions 406. Accordingly, the medical professional need not spend any time or effort on tinkering or toying with the display parameter values of any of the set of untargeted anatomical regions 406. In other words, the medical professional can manually adjust the display parameter 110 for a single one of the plurality of anatomical regions 106, and the adjustment component 120 can automatically apply some version of that manual adjustment to the display parameter 110 for each remaining one of the plurality of anatomical regions 106. In this way, a total amount of time or effort spent by the medical professional on adjusting the display parameter values of the medical image 104 can be reduced. Stated differently, the medical professional's visual inspection of the medical image 104 can be sped up or eased by various embodiments described herein, such that the medical professional can arrive at a diagnosis or prognosis more quickly than would otherwise be possible.

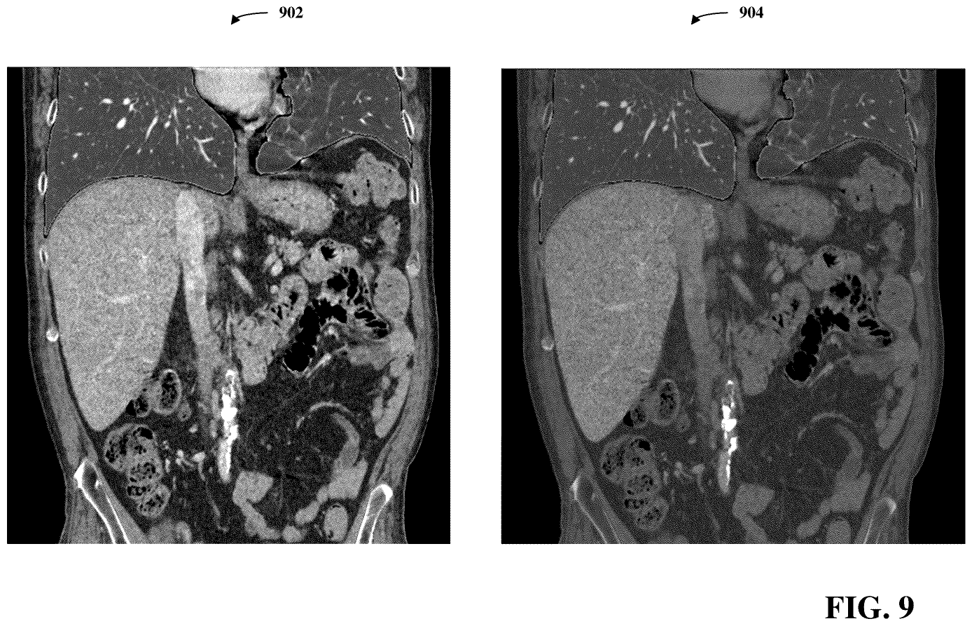

FIGS. 9-16 illustrate example, non-limiting experimental results in accordance with one or more embodiments described herein.

FIG. 9 illustrates a CT scanned image 902 depicting various anatomical regions, including a lung region, a liver region, a heart region, a body region, a bone region, and an aorta region. Each of those distinct regions has its own respective window width value and window level value. FIG. 9 also illustrates a CT scanned image 904. The CT scanned image 904 was achieved by manually adjusting the window width and window level of a single one of those distinct regions (e.g., liver). As shown, various embodiments described herein uniquely or respectively propagated such manual adjustment to each remaining region without any additional manual action or effort.

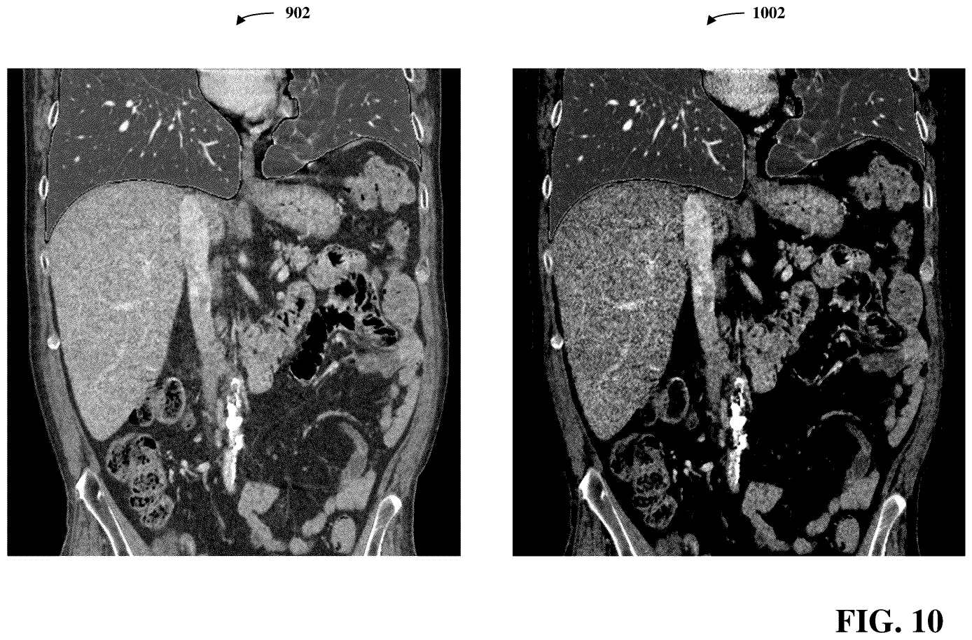

FIG. 10 illustrates the CT scanned image 902 and also a CT scanned image 1002. The CT scanned image 1002 was achieved by manually adjusting the window width and window level of a different one of those distinct regions (e.g., body). As shown, various embodiments described herein uniquely or respectively propagated such manual adjustment to each remaining region without any additional manual action or effort.

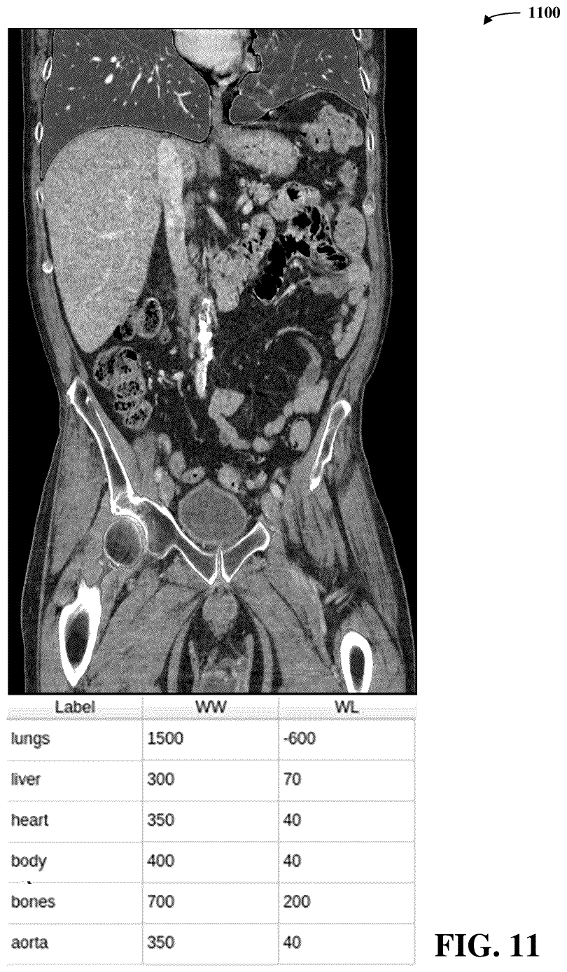

FIG. 11 shows a CT scanned image 1100 depicting a lung region, a liver region, a heart region, a body region, a bone region, and an aorta region. Also shown in FIG. 11 are the specific window width values (denoted “WW”) and the specific window level values (denoted “WL”) used for each of those regions. In particular, the lung region in the CT scanned image 1100 has a window width value of 1500 and a window level value of −600; the liver region in the CT scanned image 1100 has a window width value of 300 and a window level value of 70; the heart region in the CT scanned image 1100 has a window width value of 350 and a window level value of 40; the body region in the CT scanned image 1100 has a window width value of 400 and a window level value of 40; the bone region in the CT scanned image 1100 has a window width value of 700 and a window level value of 200; and the aorta region in the CT scanned image 1100 has a window width value of 350 and a window level value of 40.

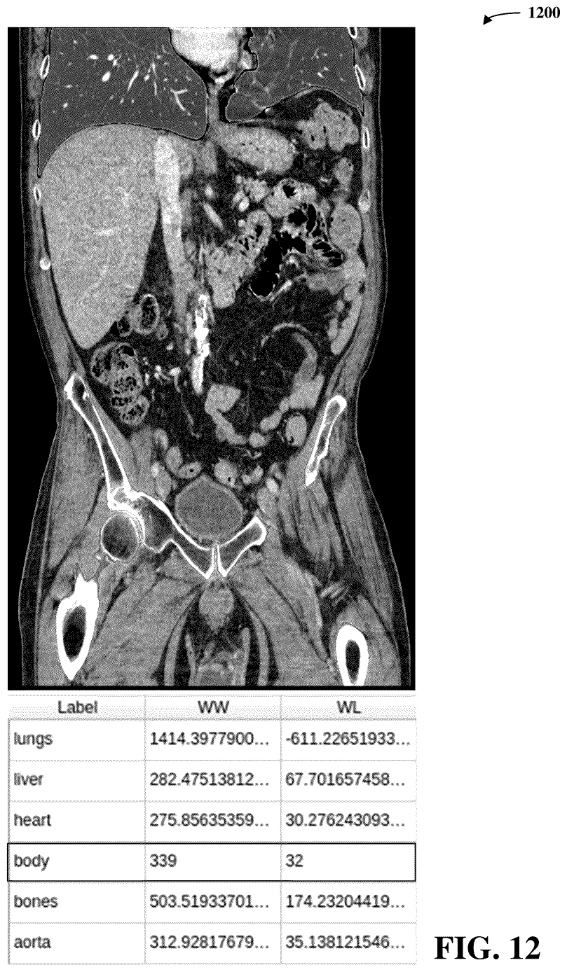

FIG. 12 shows a CT scanned image 1200, which was achieved by various embodiments described herein in response to a manual adjustment of the window width value and window level value of the body region of the CT scanned image 1100. Specifically, the window width value of the body region was changed from 400 to 339. Various embodiments described herein propagated such change to each of the remaining regions as shown: the window width value of the lung region was automatically changed from 1500 to about 1414; the window width value of the liver region was automatically changed from 300 to about 282; the window width value of the heart region was automatically changed from 350 to about 276; the window width value of the bone region was automatically changed from 700 to about 504; and the window width value of the aorta region was automatically changed from 350 to about 313. Additionally, the window level value of the body region was changed from 40 to 32. Various embodiments described herein propagated such change to each of the remaining regions as shown: the window level value of the lung region was automatically changed from −600 to about −611; the window level value of the liver region was automatically changed from 70 to about 68; the window level value of the heart region was automatically changed from 40 to about 30; the window level value of the bone region was automatically changed from 200 to about 174; and the window level value of the aorta region was automatically changed from 40 to about 35. Without various embodiments described herein, it would have taken up to several minutes for a medical professional to sequentially tinker with the window width and window level of each distinct region. However, with various embodiments described here, the medical professional can save time by tinkering with the window width and window level of only a single region (e.g., body, in this non-limiting example), and such tinkering can be automatically propagated to the window widths and window levels of all the remaining regions.

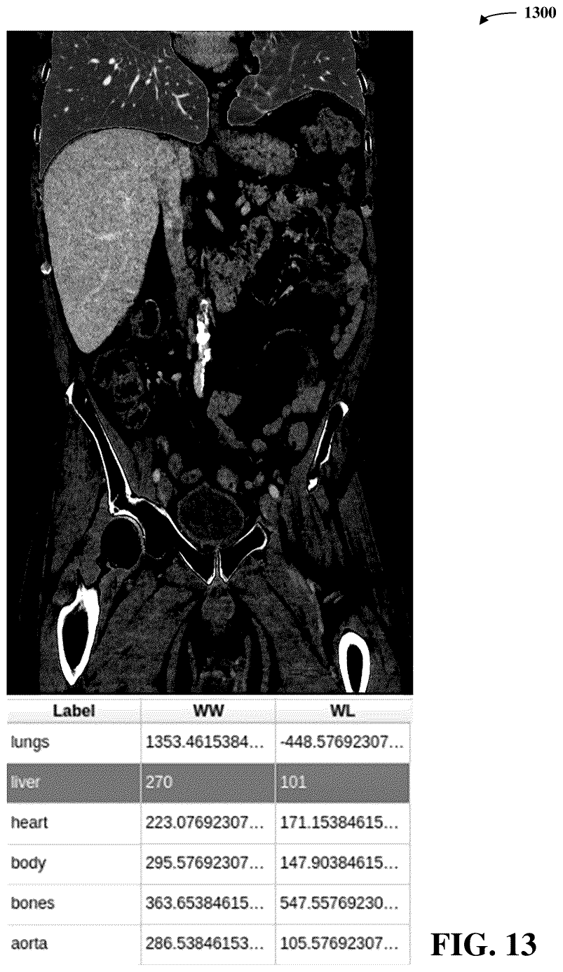

FIG. 13 shows a CT scanned image 1300, which was achieved by various embodiments described herein in response to a manual adjustment of the window width value and window level value of the liver region of the CT scanned image 1100. Specifically, the window width value of the liver region was changed from 300 to 270. Various embodiments described herein propagated such change to each of the remaining regions as shown: the window width value of the lung region was automatically changed from 1500 to about 1353; the window width value of the heart region was automatically changed from 350 to about 223; the window width value of the body region was automatically changed from 400 to about 296; the window width value of the bone region was automatically changed from 700 to about 364; and the window width value of the aorta region was automatically changed from 350 to about 287. Additionally, the window level value of the liver region was changed from 70 to 101. Various embodiments described herein propagated such change to each of the remaining regions as shown: the window level value of the lung region was automatically changed from −600 to about −449; the window level value of the heart region was automatically changed from 40 to about 171; the window level value of the body region was automatically changed from 40 to about 148; the window level value of the bone region was automatically changed from 200 to about 548; and the window level value of the aorta region was automatically changed from 40 to about 106. Without various embodiments described herein, it would have taken up to several minutes for a medical professional to sequentially tinker with the window width and window level of each distinct region. However, with various embodiments described here, the medical professional can save time by tinkering with the window width and window level of only a single region (e.g., liver, in this non-limiting example), and such tinkering can be automatically propagated to the window widths and window levels of all the remaining regions.

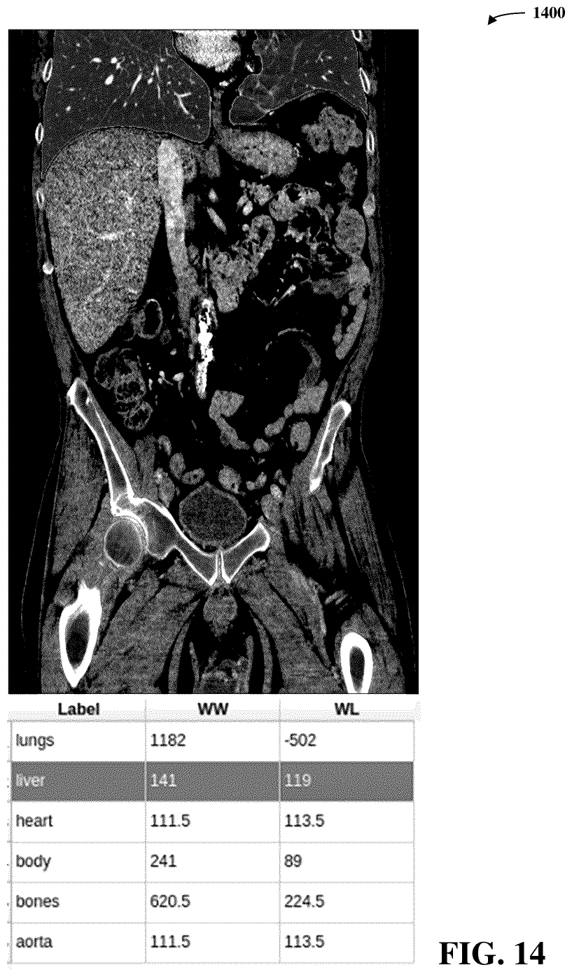

FIG. 14 shows a CT scanned image 1400, which was achieved by various embodiments described herein in response to a manual adjustment of the window width value and window level value of the liver region of the CT scanned image 1100. Specifically, the window width value of the liver region was changed from 300 to 141. Various embodiments described herein propagated such change to each of the remaining regions as shown: the window width value of the lung region was automatically changed from 1500 to 1182; the window width value of the heart region was automatically changed from 350 to about 112; the window width value of the body region was automatically changed from 400 to 241; the window width value of the bone region was automatically changed from 700 to about 621; and the window width value of the aorta region was automatically changed from 350 to about 112. Additionally, the window level value of the liver region was changed from 70 to 119. Various embodiments described herein propagated such change to each of the remaining regions as shown: the window level value of the lung region was automatically changed from −600 to about −502; the window level value of the heart region was automatically changed from 40 to about 114; the window level value of the body region was automatically changed from 40 to 89; the window level value of the bone region was automatically changed from 200 to about 225; and the window level value of the aorta region was automatically changed from 40 to about 114. Without various embodiments described herein, it would have taken up to several minutes for a medical professional to sequentially tinker with the window width and window level of each distinct region. However, with various embodiments described here, the medical professional can save time by tinkering with the window width and window level of only a single region (e.g., liver, in this non-limiting example), and such tinkering can be automatically propagated to the window widths and window levels of all the remaining regions.

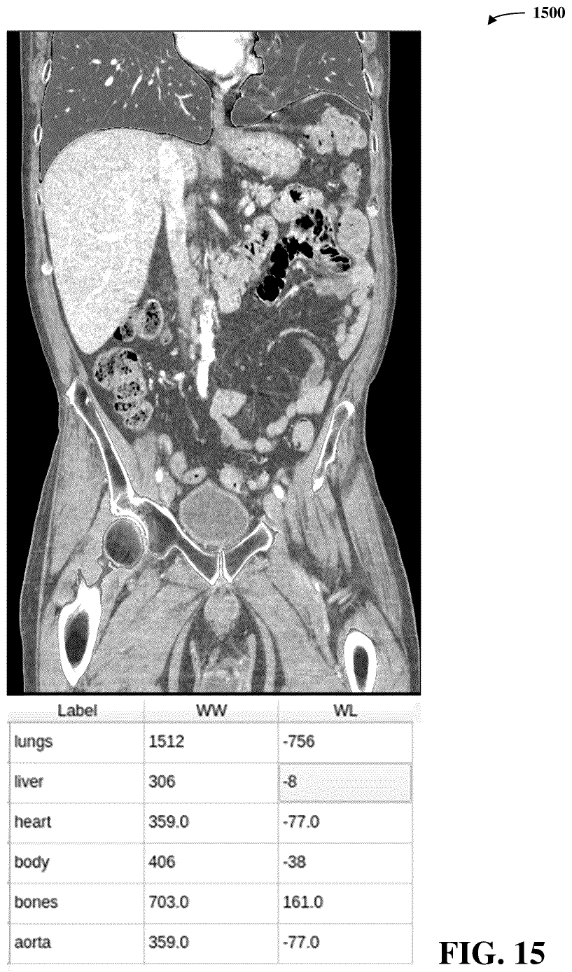

FIG. 15 shows a CT scanned image 1500, which was achieved by various embodiments described herein in response to a manual adjustment of the window width value and window level value of the liver region of the CT scanned image 1100. Specifically, the window width value of the liver region was changed from 300 to 306. Various embodiments described herein propagated such change to each of the remaining regions as shown: the window width value of the lung region was automatically changed from 1500 to 1512; the window width value of the heart region was automatically changed from 350 to 359; the window width value of the body region was automatically changed from 400 to 406; the window width value of the bone region was automatically changed from 700 to about 703; and the window width value of the aorta region was automatically changed from 350 to about 359. Additionally, the window level value of the liver region was changed from 70 to −8. Various embodiments described herein propagated such change to each of the remaining regions as shown: the window level value of the lung region was automatically changed from −600 to about −756; the window level value of the heart region was automatically changed from 40 to −77; the window level value of the body region was automatically changed from 40 to −38; the window level value of the bone region was automatically changed from 200 to 161; and the window level value of the aorta region was automatically changed from 40 to −77. Without various embodiments described herein, it would have taken up to several minutes for a medical professional to sequentially tinker with the window width and window level of each distinct region. However, with various embodiments described here, the medical professional can save time by tinkering with the window width and window level of only a single region (e.g., liver, in this non-limiting example), and such tinkering can be automatically propagated to the window widths and window levels of all the remaining regions.

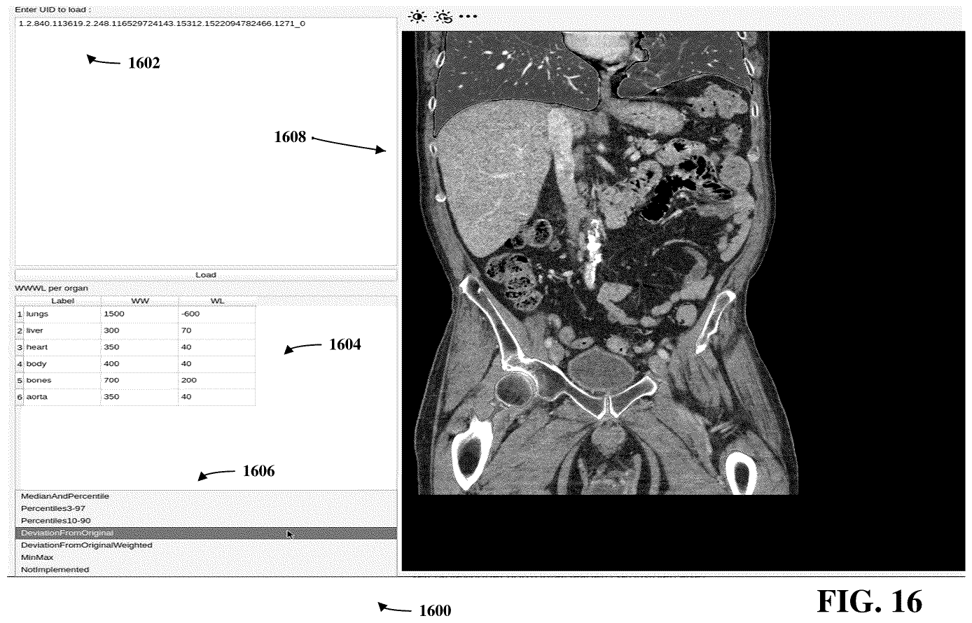

FIG. 16 illustrates a screen shot 1600 of a reduction to practice of various embodiments described herein. Specifically, the screen shot 1600 shows a real-world graphical user interface of a real-world computer program created in accordance with various embodiments described herein. Such graphical user interface includes a medical image 1608 being visually rendered, a field 1602 which indicates an alphanumeric identifier of the medical image 1608, a field 1604 which indicates region-wise display parameter values that are currently or presently being used to visually render the medical image 1608 (e.g., indicates window width value and window level value for each anatomical region in the medical image 1608), and a field 1606 which indicates different ways by which display parameter adjustment can be propagated across anatomical regions (e.g., a “percentiles3-97” way can involve the statistical intensity metric 604 being an arithmetic difference between a 97-th percentile intensity value and a 3-rd percentile intensity value exhibited by the pixels or voxels of the target anatomical region 402; a “percentiles10-90” way can involve the statistical intensity metric 604 being an arithmetic difference between a 90-th percentile intensity value and a 10-th percentile intensity value exhibited by the pixels or voxels of the target anatomical region 402; a “MinMax” way can involve the statistical intensity metric 604 being an arithmetic difference between a maximum intensity value and a minimum intensity value exhibited by the pixels or voxels of the target anatomical region 402; a “notimplemented” way can involve ceasing or prohibiting propagation across anatomical regions).

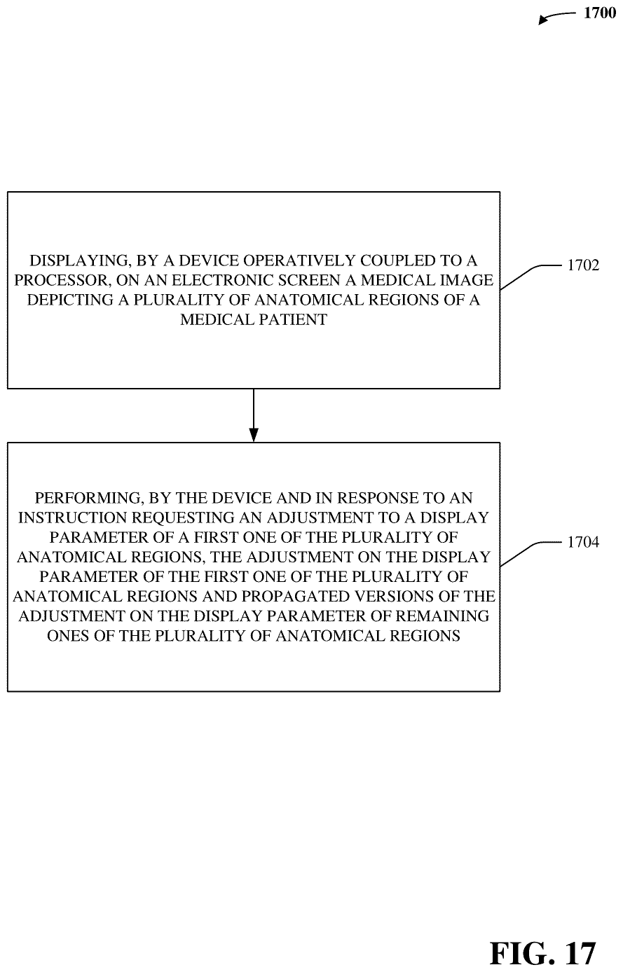

FIG. 17 illustrates a flow diagram of an example, non-limiting computer-implemented method 1700 that can facilitate region-wise propagation of display parameter adjustments in accordance with one or more embodiments described herein. In various cases, the display propagation system 102 can facilitate the computer-implemented method 1700.

In various embodiments, act 1702 can include displaying, by a device (e.g., via 118) operatively coupled to a processor (e.g., 114), on an electronic screen (e.g., 108) a medical image (e.g., 104) depicting a plurality of anatomical regions (e.g., 106) of a medical patient.

In various aspects, act 1704 can include performing, by the device (e.g., via 120) and in response to an instruction requesting an adjustment (e.g., 302) to a display parameter (e.g., 110) of a first one (e.g., 402) of the plurality of anatomical regions, the adjustment on the display parameter of the first one of the plurality of anatomical regions and propagated versions (e.g., 304) of the adjustment on the display parameter of remaining ones of the plurality of anatomical regions.

Although not explicitly shown in FIG. 17, the adjustment and the propagated versions of the adjustment can be in opposite directions or can instead be in a same direction as each other.

Although not explicitly shown in FIG. 17, the propagated versions of the adjustment can be generated via an adjustment coefficient (e.g., 602), wherein the adjustment coefficient can be based on a current value (e.g., 408) of the display parameter of the first one of the plurality of anatomical regions and based on a target value (e.g., 404) of the display parameter of the first one of the plurality of anatomical regions indicated by the instruction. In various instances, the adjustment coefficient can be further based on a statistical intensity metric (e.g., 604) exhibited by whatever pixels or voxels make up the first one of the plurality of anatomical regions. In some cases, the adjustment coefficient can be applied to the display parameter of the remaining ones of the plurality of anatomical regions in a weighted fashion (e.g., using weights such as 608).

Although not explicitly shown in FIG. 17, the propagated versions of the adjustment can be generated via execution of a machine learning model (e.g., 704) on the adjustment indicated by the instruction.

Although the herein disclosure has mainly described various embodiments in which the set of propagated display adjustments 304 contain n−1 adjustments (e.g., contain one propagated adjustment per untargeted anatomical region), these are mere non-limiting examples for ease of explanation and illustration. In various cases, the set of propagated display adjustments 304 can contain fewer than n−1 adjustments (e.g., the requested display adjustment 302 can be not propagated to some of the set of untargeted anatomical structures 406).

Various embodiments described herein can be implemented as a computer program product comprising a non-transitory computer-readable memory (e.g., 116) having program instructions embodied therewith. In various aspects, the program instructions can be executable by a processor (e.g., 114) to cause the processor to: render a scanned medical image (e.g., 104); and propagate, in response to an input specifying an adjustment (e.g., 302) to be made to a rendition parameter (e.g., 110) of a first anatomical structure (e.g., 402) depicted in the scanned medical image, a version (e.g., any of 304) of the adjustment to the rendition parameter of a second anatomical structure (e.g., any of 406) depicted in the scanned medical image.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

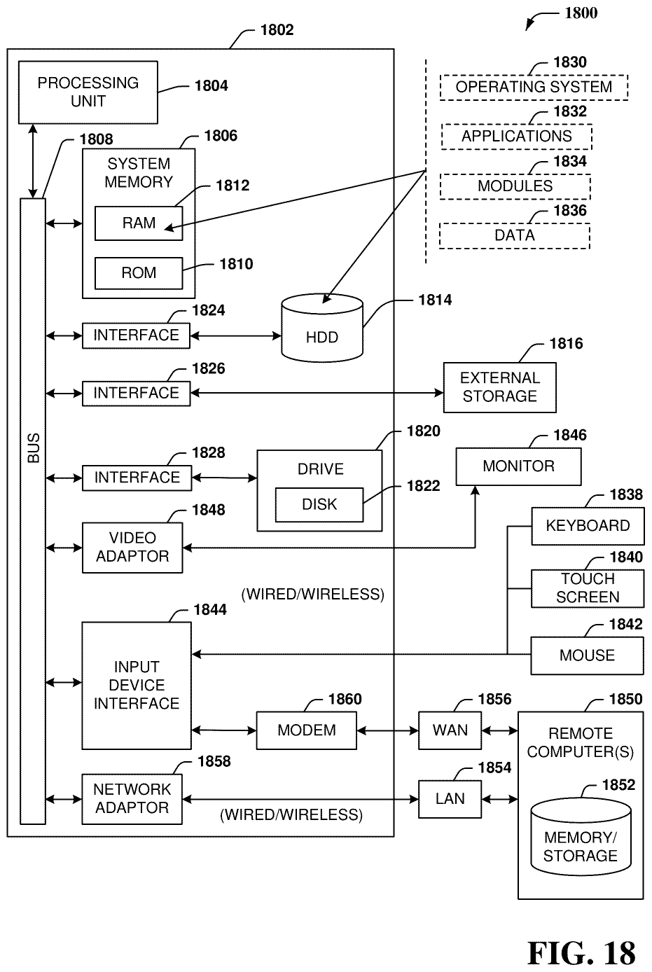

In order to provide additional context for various embodiments described herein, FIG. 18 and the following discussion are intended to provide a brief, general description of a suitable computing environment 1800 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 18, the example environment 1800 for implementing various embodiments of the aspects described herein includes a computer 1802, the computer 1802 including a processing unit 1804, a system memory 1806 and a system bus 1808. The system bus 1808 couples system components including, but not limited to, the system memory 1806 to the processing unit 1804. The processing unit 1804 can be any of various commercially available processors. Dual microprocessors and other multi-processor architectures can also be employed as the processing unit 1804.

The system bus 1808 can be any of several types of bus structure that can further interconnect to a memory bus (with or without a memory controller), a peripheral bus, and a local bus using any of a variety of commercially available bus architectures. The system memory 1806 includes ROM 1810 and RAM 1812. A basic input/output system (BIOS) can be stored in a non-volatile memory such as ROM, erasable programmable read only memory (EPROM), EEPROM, which BIOS contains the basic routines that help to transfer information between elements within the computer 1802, such as during startup. The RAM 1812 can also include a high-speed RAM such as static RAM for caching data.

The computer 1802 further includes an internal hard disk drive (HDD) 1814 (e.g., EIDE, SATA), one or more external storage devices 1816 (e.g., a magnetic floppy disk drive (FDD) 1816, a memory stick or flash drive reader, a memory card reader, etc.) and a drive 1820, e.g., such as a solid state drive, an optical disk drive, which can read or write from a disk 1822, such as a CD-ROM disc, a DVD, a BD, etc. Alternatively, where a solid state drive is involved, disk 1822 would not be included, unless separate. While the internal HDD 1814 is illustrated as located within the computer 1802, the internal HDD 1814 can also be configured for external use in a suitable chassis (not shown). Additionally, while not shown in environment 1800, a solid state drive (SSD) could be used in addition to, or in place of, an HDD 1814. The HDD 1814, external storage device(s) 1816 and drive 1820 can be connected to the system bus 1808 by an HDD interface 1824, an external storage interface 1826 and a drive interface 1828, respectively. The interface 1824 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1802, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1812, including an operating system 1830, one or more application programs 1832, other program modules 1834 and program data 1836. All or portions of the operating system, applications, modules, or data can also be cached in the RAM 1812. The systems and methods described herein can be implemented utilizing various commercially available operating systems or combinations of operating systems.

Computer 1802 can optionally comprise emulation technologies. For example, a hypervisor (not shown) or other intermediary can emulate a hardware environment for operating system 1830, and the emulated hardware can optionally be different from the hardware illustrated in FIG. 18. In such an embodiment, operating system 1830 can comprise one virtual machine (VM) of multiple VMs hosted at computer 1802. Furthermore, operating system 1830 can provide runtime environments, such as the Java runtime environment or the .NET framework, for applications 1832. Runtime environments are consistent execution environments that allow applications 1832 to run on any operating system that includes the runtime environment. Similarly, operating system 1830 can support containers, and applications 1832 can be in the form of containers, which are lightweight, standalone, executable packages of software that include, e.g., code, runtime, system tools, system libraries and settings for an application.

Further, computer 1802 can be enable with a security module, such as a trusted processing module (TPM). For instance with a TPM, boot components hash next in time boot components, and wait for a match of results to secured values, before loading a next boot component. This process can take place at any layer in the code execution stack of computer 1802, e.g., applied at the application execution level or at the operating system (OS) kernel level, thereby enabling security at any level of code execution.

A user can enter commands and information into the computer 1802 through one or more wired/wireless input devices, e.g., a keyboard 1838, a touch screen 1840, and a pointing device, such as a mouse 1842. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1804 through an input device interface 1844 that can be coupled to the system bus 1808, but can be connected by other interfaces, such as a parallel port, an IEEE 1394 serial port, a game port, a USB port, an IR interface, a BLUETOOTH® interface, etc.

A monitor 1846 or other type of display device can be also connected to the system bus 1808 via an interface, such as a video adapter 1848. In addition to the monitor 1846, a computer typically includes other peripheral output devices (not shown), such as speakers, printers, etc.

The computer 1802 can operate in a networked environment using logical connections via wired or wireless communications to one or more remote computers, such as a remote computer(s) 1850. The remote computer(s) 1850 can be a workstation, a server computer, a router, a personal computer, portable computer, microprocessor-based entertainment appliance, a peer device or other common network node, and typically includes many or all of the elements described relative to the computer 1802, although, for purposes of brevity, only a memory/storage device 1852 is illustrated. The logical connections depicted include wired/wireless connectivity to a local area network (LAN) 1854 or larger networks, e.g., a wide area network (WAN) 1856. Such LAN and WAN networking environments are commonplace in offices and companies, and facilitate enterprise-wide computer networks, such as intranets, all of which can connect to a global communications network, e.g., the Internet.

When used in a LAN networking environment, the computer 1802 can be connected to the local network 1854 through a wired or wireless communication network interface or adapter 1858. The adapter 1858 can facilitate wired or wireless communication to the LAN 1854, which can also include a wireless access point (AP) disposed thereon for communicating with the adapter 1858 in a wireless mode.

When used in a WAN networking environment, the computer 1802 can include a modem 1860 or can be connected to a communications server on the WAN 1856 via other means for establishing communications over the WAN 1856, such as by way of the Internet. The modem 1860, which can be internal or external and a wired or wireless device, can be connected to the system bus 1808 via the input device interface 1844. In a networked environment, program modules depicted relative to the computer 1802 or portions thereof, can be stored in the remote memory/storage device 1852. It will be appreciated that the network connections shown are example and other means of establishing a communications link between the computers can be used.

When used in either a LAN or WAN networking environment, the computer 1802 can access cloud storage systems or other network-based storage systems in addition to, or in place of, external storage devices 1816 as described above, such as but not limited to a network virtual machine providing one or more aspects of storage or processing of information. Generally, a connection between the computer 1802 and a cloud storage system can be established over a LAN 1854 or WAN 1856 e.g., by the adapter 1858 or modem 1860, respectively. Upon connecting the computer 1802 to an associated cloud storage system, the external storage interface 1826 can, with the aid of the adapter 1858 or modem 1860, manage storage provided by the cloud storage system as it would other types of external storage. For instance, the external storage interface 1826 can be configured to provide access to cloud storage sources as if those sources were physically connected to the computer 1802.

The computer 1802 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

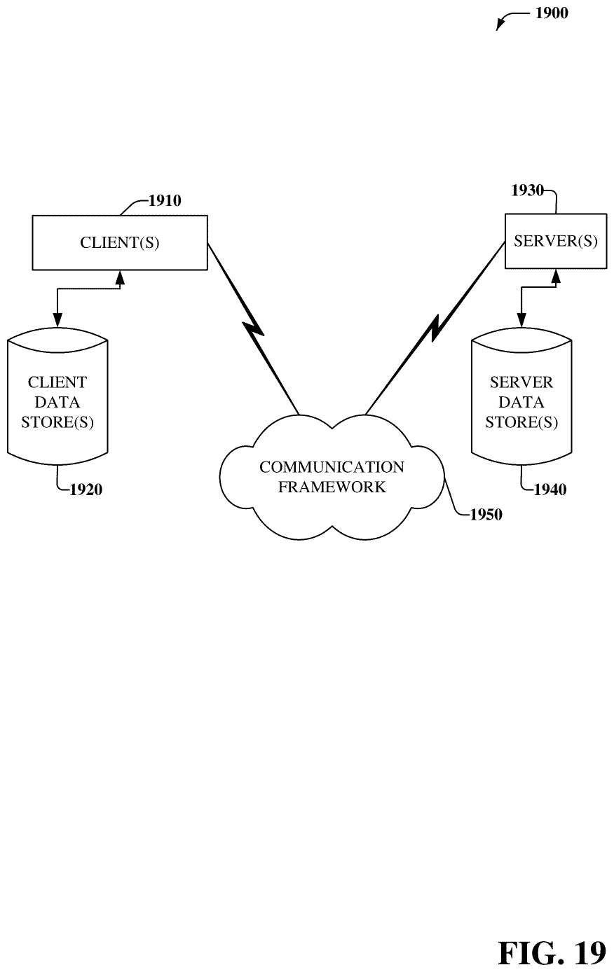

FIG. 19 is a schematic block diagram of a sample computing environment 1900 with which the disclosed subject matter can interact. The sample computing environment 1900 includes one or more client(s) 1910. The client(s) 1910 can be hardware or software (e.g., threads, processes, computing devices). The sample computing environment 1900 also includes one or more server(s) 1930. The server(s) 1930 can also be hardware or software (e.g., threads, processes, computing devices). The servers 1930 can house threads to perform transformations by employing one or more embodiments as described herein, for example. One possible communication between a client 1910 and a server 1930 can be in the form of a data packet adapted to be transmitted between two or more computer processes. The sample computing environment 1900 includes a communication framework 1950 that can be employed to facilitate communications between the client(s) 1910 and the server(s) 1930. The client(s) 1910 are operably connected to one or more client data store(s) 1920 that can be employed to store information local to the client(s) 1910. Similarly, the server(s) 1930 are operably connected to one or more server data store(s) 1940 that can be employed to store information local to the servers 1930.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a solid state drive such as M.2 (including non-volatile memory express (NVMe) or serial advanced technology attachment (SATA)), a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, wherein the computer-executable components comprise:
a display component that displays on an electronic screen a medical image depicting a plurality of anatomical regions of a medical patient; and
an adjustment component that, in response to an instruction requesting an adjustment to a display parameter of a first one of the plurality of anatomical regions, performs the adjustment on the display parameter of the first one of the plurality of anatomical regions and performs propagated versions of the adjustment on the display parameter of remaining ones of the plurality of anatomical regions.

2. The system of claim 1, wherein the adjustment and the propagated versions of the adjustment are in opposite directions.

3. The system of claim 1, wherein the adjustment and the propagated versions of the adjustment are in a same direction.

4. The system of claim 1, wherein the adjustment component generates the propagated versions of the adjustment via an adjustment coefficient, wherein the adjustment coefficient is based on a current value of the display parameter of the first one of the plurality of anatomical regions and based on a target value of the display parameter of the first one of the plurality of anatomical regions indicated by the instruction.

5. The system of claim 4, wherein the adjustment coefficient is further based on a statistical intensity metric exhibited by whatever pixels or voxels make up the first one of the plurality of anatomical regions.

6. The system of claim 4, wherein the adjustment component applies the adjustment coefficient to the display parameter of the remaining ones of the plurality of anatomical regions in a weighted fashion.

7. The system of claim 1, wherein the adjustment component generates the propagated versions of the adjustment via execution of a machine learning model on the adjustment indicated by the instruction.

8. The system of claim 1, wherein the medical image is a computed tomography scanned image, a magnetic resonance imaging scanned image, an ultrasound scanned image, an X-ray scanned image, a positron emission tomography scanned image, or a nuclear medicine scanned image.

9. The system of claim 1, wherein the display parameter is a window width or a window level.

10. A computer-implemented method, comprising:
displaying, by a device operatively coupled to a processor, on an electronic screen a medical image depicting a plurality of anatomical regions of a medical patient; and
performing, by the device and in response to an instruction requesting an adjustment to a display parameter of a first one of the plurality of anatomical regions, the adjustment on the display parameter of the first one of the plurality of anatomical regions and propagated versions of the adjustment on the display parameter of remaining ones of the plurality of anatomical regions.

11. The computer-implemented method of claim 10, wherein the adjustment and the propagated versions of the adjustment are in opposite directions.

12. The computer-implemented method of claim 10, wherein the adjustment and the propagated versions of the adjustment are in a same direction.

13. The computer-implemented method of claim 10, wherein the propagated versions of the adjustment are generated via an adjustment coefficient, wherein the adjustment coefficient is based on a current value of the display parameter of the first one of the plurality of anatomical regions and based on a target value of the display parameter of the first one of the plurality of anatomical regions indicated by the instruction.

14. The computer-implemented method of claim 13, wherein the adjustment coefficient is further based on a statistical intensity metric exhibited by whatever pixels or voxels make up the first one of the plurality of anatomical regions.

15. The computer-implemented method of claim 13, wherein the adjustment coefficient is applied to the display parameter of the remaining ones of the plurality of anatomical regions in a weighted fashion.

16. The computer-implemented method of claim 10, wherein the propagated versions of the adjustment are generated via execution of a machine learning model on the adjustment indicated by the instruction.

17. The computer-implemented method of claim 10, wherein the medical image is a computed tomography scanned image, a magnetic resonance imaging scanned image, an ultrasound scanned image, an X-ray scanned image, a positron emission tomography scanned image, or a nuclear medicine scanned image.

18. The computer-implemented method of claim 10, wherein the display parameter is a window width or a window level.

19. A computer program product for facilitating region-wise propagation of display parameter adjustments, the computer program product comprising a non-transitory computer-readable memory having program instructions embodied therewith, the program instructions executable by a processor to cause the processor to:
render a scanned medical image; and
propagate, in response to an input specifying an adjustment to be made to a rendition parameter of a first anatomical structure depicted in the scanned medical image, a version of the adjustment to the rendition parameter of a second anatomical structure depicted in the scanned medical image.

20. The computer program product of claim 19, wherein the rendition parameter is window width or window level.
